SEQUENCE LISTING (40 sequences)

SEQ ID NO: 1 - DNA, 30 bp, Artificial
  Synthesised in laboratory
acgttggatgtggacatggtgaatgacggc

SEQ ID NO: 2 - DNA, 30 bp, Artificial
  Synthesised in laboratory
acgttggatgtggtgcagatgctcacatag

SEQ ID NO: 3 - DNA, 30 bp, Artificial
  Synthesised in laboratory
acgttggatgactcacagagcacattcacg

SEQ ID NO: 4 - DNA, 30 bp, Artificial
  Synthesised in laboratory
acgttggatgtgtcactcgagatcttgagg

SEQ ID NO: 5 - DNA, 30 bp, Artificial
  Synthesised in laboratory
acgttggatgagacacagaaccctagatgc

SEQ ID NO: 6 - DNA, 30 bp, Artificial
  Synthesised in laboratory
acgttggatgcaatgaaggatgtttcaggg

SEQ ID NO: 7 - DNA, 30 bp, Artificial
  Synthesised in laboratory
acgttggatgtggaagaagcaggtggagat

SEQ ID NO: 8 - DNA, 30 bp, Artificial
  Synthesised in laboratory
acgttggatgctggcgttttgcaaacatac

SEQ ID NO: 9 - DNA, 30 bp, Artificial
  Synthesised in laboratory
acgttggatgtggagacgtctgcaggtatg

SEQ ID NO: 10 - DNA, 30 bp, Artificial
  Synthesised in laboratory
acgttggatgcctgccaaagaagaaacacc

SEQ ID NO: 11 - DNA, 30 bp, Artificial
  Synthesised in laboratory
acgttggatgtgagtcttcaaagttcctgc

SEQ ID NO: 12 - DNA, 30 bp, Artificial
  Synthesised in laboratory
acgttggatgaacatccttccatggatgag

SEQ ID NO: 13 - DNA, 30 bp, Artificial
  Synthesised in laboratory
acgttggatgacatctctttctgcatcccc

SEQ ID NO: 14 - DNA, 30 bp, Artificial
  Synthesised in laboratory
acgttggatggaaagatgtgcgctgatagg

SEQ ID NO: 15 - DNA, 30 bp, Artificial
  Synthesised in laboratory
acgttggatgaaaccatgacaccttcctgc

SEQ ID NO: 16 - DNA, 29 bp, Artificial
  Synthesised in laboratory
acgttggatgagtcggtagcaacaccagg

SEQ ID NO: 17 - DNA, 16 bp, Artificial
  Synthesised in laboratory
cctccgctgcaaatac

SEQ ID NO: 18 - DNA, 17 bp, Artificial
  Synthesised in laboratory
cctccgctgcaaataca

SEQ ID NO: 19 - DNA, 17 bp, Artificial
  Synthesised in laboratory
tacattcacggtcacct

SEQ ID NO: 20 - DNA, 18 bp, Artificial
  Synthesised in laboratory
tacattcacggtcacctc

SEQ ID NO: 21 - DNA, 17 bp, Artificial
  Synthesised in laboratory
aatccttcctgttacgg

SEQ ID NO: 22 - DNA, 18 bp, Artificial
  Synthesised in laboratory
aatccttcctgttacggc

SEQ ID NO: 23 - DNA, 19 bp, Artificial
  Synthesised in laboratory
ggtggagattctcaacaga

SEQ ID NO: 24 - DNA, 20 bp, Artificial
  Synthesised in laboratory
ggtggagattctcaacagac

SEQ ID NO: 25 - DNA, 23 bp, Artificial
  Synthesised in laboratory
tagactcaaaatcttcaattgtt

SEQ ID NO: 26 - DNA, 24 bp, Artificial
  Synthesised in laboratory
tagactcaaaatcttcaattgttc

SEQ ID NO: 27 - DNA, 24 bp, Artificial
  Synthesised in laboratory
catgcttattcattacagatctta

SEQ ID NO: 28 - DNA, 25 bp, Artificial
  Synthesised in laboratory
catgcttattcattacagatcttac

SEQ ID NO: 29 - DNA, 16 bp, Artificial
  Synthesised in laboratory
tccccgtctttctcca

SEQ ID NO: 30 - DNA, 17 bp, Artificial
  Synthesised in laboratory
tccccgtctttctccac

SEQ ID NO: 31 - DNA, 17 bp, Artificial
  Synthesised in laboratory
ctgcctctgctcccagg

SEQ ID NO: 32 - DNA, 18 bp, Artificial
  Synthesised in laboratory
ctgcctctgctcccaggc

SEQ ID NO: 33 - DNA, 17 bp, Artificial
  Synthesised in laboratory
cctccgctgcaaatacg

SEQ ID NO: 34 - DNA, 18 bp, Artificial
  Synthesised in laboratory
tacattcacggtcacctt

SEQ ID NO: 35 - DNA, 18 bp, Artificial
  Synthesised in laboratory
aatccttcctgttacggt

SEQ ID NO: 36 - DNA, 20 bp, Artificial
  Synthesised in laboratory
ggtggagattctcaacagat

SEQ ID NO: 37 - DNA, 24 bp, Artificial
  Synthesised in laboratory
tagactcaaaatcttcaattgttt

SEQ ID NO: 38 - DNA, 25 bp, Artificial
  Synthesised in laboratory
catgcttattcattacagatcttat

SEQ ID NO: 39 - DNA, 17 bp, Artificial
  Synthesised in laboratory
tccccgtctttctccat

SEQ ID NO: 40 - DNA, 18 bp, Artificial
  Synthesised in laboratory
ctgcctctgctcccaggg

(19) United States
(12) Patent Application Publication
(10) Pub. No.: US 2010/0285973 A1
(43) Pub. Date: Nov. 11, 2010

(54) METHODS AND COMPOSITIONS FOR ASSESSMENT OF PULMONARY FUNCTION AND DISORDERS

(75) Inventor: Robert Peter Young, Auckland (NZ)

Correspondence Address: DAVIS WRIGHT TREMAINE LLP - San Francisco, 505 MONTGOMERY STREET, SUITE 800, SAN FRANCISCO, CA, 94111, US

(73) Assignee: Synergenz Bioscience Limited of Sea Meadow House, Tortola (VG)

(21) Appl. No.: 12/302,741

(22) PCT Filed: May 30, 2007
(86) PCT No.: PCT/NZ2007/000132

§ 371 Date: Jul. 26, 2010

(30) Foreign Application Priority Data
May 30, 2006 (NZ) 547579

(51) Int. Cl. C40B 30/00

(52) U.S. Cl. 506/7

(57) ABSTRACT

The present invention provides methods for the assessment risk of developing asthma in smokers and non-smokers using analysis of genetic polymorphisms. The present invention also relates to the use of genetic polymorphisms in assessing a subject's risk of developing asthma. Nucleotide probes and primers, kits, and microarrays suitable for such assessment are also provided.

### FIELD OF THE INVENTION

The present invention is concerned with methods for assessment of pulmonary function and/or disorders, and in particular for assessing risk of developing asthma in smokers and non-smokers using analysis of genetic polymorphisms and altered gene expression.

### BACKGROUND OF THE INVENTION

Asthma is a common chronic inflammatory condition characterised by airway obstruction which may result from airway remodelling from early life [1] and/or an increased rate of decline in lung function in patients with asthma [see, for example, 2 and 3]. Asthma is also reportedly associated with hyper-responsiveness attributed to an underlying inflammatory process and bronchial structural changes [4].

In adults, it is difficult to determine the longitudinal effects of asthma on lung function because of the confounding effects, of factors such as cigarette smoking [3], occupational exposures [5], raised white cell count [6], and concomitant lung diseases such as bronchitis or emphysema M. Treatment with inhaled corticosteroids improves or reverses airway inflammation [8] and airway remodelling [9], and may reduce the rate of decline of lung function in subjects with asthma [10]. Although many subjects with asthma continue to smoke cigarettes, there has been limited investigation of the interaction of the effects of cigarette smoking and asthma on the rate of decline in lung function. One such study reported that compared with nonsmokers without asthma, the rate of decline in FEV₁ was greater in those with asthma and in those who smoked and greatest in those with asthma who smoked; lung function at the age of 20 years was similar in the subjects with and without asthma [3].

During the last 20 years a significant increase in both the prevalence and mortality of asthma has been reported [11]. As a result, it has become increasingly important to understand better the natural history of asthma and its long-term consequences, especially in terms of its effect on pulmonary function. This has proven to be a very challenging task due to the complex nature of the disease.

It has been suggested that asthma has a genetic component that relates to susceptibility and that there is an interaction with environmental stimuli that are potential disease triggers [12]. It has also been reported that the timing of exposure to risk factors is important [13]. Understanding the time course of changes in pulmonary function among asthmatics is critical for better understanding and treating complications related to this complex disease.

Despite advances in the treatment of airways disease, current therapies do not significantly alter the natural history of asthma, which may include progressive loss of lung function causing respiratory failure and death. Although cessation of smoking may be expected to reduce this decline in lung function, it is probable that if this is not achieved at an early stage, the loss is considerable and symptoms of worsening breathlessness likely cannot be averted. Analogous to the discovery of serum cholesterol and its link to coronary artery disease, there is a need to better understand the factors that contribute to asthma so that tests that identify at risk subjects can be developed and that new treatments can be discovered to reduce the adverse effects of asthma. The early diagnosis of asthma or of a propensity to developing asthma enables a broader range of prophylactic or therapeutic treatments to be employed than can be employed in the treatment of late stage asthma or irreversible asthma. Such prophylactic or early therapeutic treatment is also more likely to be successful, achieve remission, improve quality of life, and/or increase lifespan.

To date, a number of biomarkers useful in the diagnosis and assessment of propensity towards developing various pulmonary disorders have been identified. These include, for example, single nucleotide polymorphisms including the following: A-82G in the promoter of the gene encoding human macrophage elastase (MMP12); T→C within codon 10 of the gene encoding transforming growth factor beta (TGFβ); C+760G of the gene encoding superoxide dismutase 3 (SOD3); T-1296C within the promoter of the gene encoding tissue inhibitor of metalloproteinase 3 (TIMP3); and polymorphisms in linkage disequilibrium with these polymorphisms, as disclosed in PCT International Application PCT/NZ02/00106 (published as WO 02/099134 and incorporated by reference herein in its entirety).

It would be desirable and advantageous to have additional biomarkers which could be used to assess a subject's risk of developing asthma, or a risk of developing asthma-related impaired lung function, particularly if the subject is a smoker.

It is primarily to such biomarkers and their use in methods to assess risk of developing asthma that the present invention is directed.

### SUMMARY OF THE INVENTION

The present invention is primarily based on the finding that certain polymorphisms are found more often in subjects with asthma than in control subjects. Analysis of these polymorphisms reveals an association between polymorphisms and the subject's risk of developing asthma.

Thus, according to one aspect there is provided a method of determining a subject's risk of developing asthma comprising analysing a sample from said subject for the presence or absence of one or more polymorphisms selected from the group consisting of:
+489 G/A in the gene encoding Tissue Necrosis Factor α (TNF α); or
Tyr 113 His T/C (Exon3) in the gene encoding Microsomal epoxide hydrolase (MEH);

wherein the presence or absence of one or more of said polymorphisms is indicative of the subject's risk of developing asthma.

The one or more polymorphisms can be detected directly or by detection of one or more polymorphisms which are in linkage disequilibrium with said one or more polymorphisms.

Linkage disequilibrium (LD) is a phenomenon in genetics whereby two or more mutations or polymorphisms are in such close genetic proximity that they are co-inherited. This means that in genotyping, detection of one polymorphism as present infers the presence of the other. (Reich D E et al; Linkage disequilibrium in the human genome, Nature 2001, 411:199-204.)

The method can additionally comprise analysing a sample from said subject for the presence or absence of one or more further polymorphisms selected from the group consisting of:
Ile 105 Val A/G in the gene encoding Glutathione S Transferase P (GSTP1);
Arg 197 Gln A/G in the gene encoding N-acetyltransferase 2 (NAT2);
−159 C/T in the gene encoding CD14;
+2151 G/C in the gene encoding ADAM 33;
−403 C/T in the gene encoding RANTES; or
E469K A/G in the gene encoding Intra-cellular adhesion molecule (ICAM1).

Again, detection of the one or more further polymorphisms may be carried out directly or by detection of polymorphisms in linkage disequilibrium with the one or more further polymorphisms.

The presence of one or more polymorphisms selected from the group consisting of:
the Ile 105 Val A/G AA genotype in the gene encoding GSTP1;
the +489 G/A GG genotype in the gene encoding TNF α;
the −159 C/T CC genotype in the gene encoding CD14;
the +2151 G/C CC or CO genotype in the gene encoding ADAM 33; or
the −403 C/T TT genotype in the gene encoding RANTES;
   may be indicative of a reduced risk of developing asthma.

The presence of one or more polymorphisms selected from the group consisting of:
the Arg 197 Gln A/G AA genotype in the gene encoding NAT2;
the +489 G/A AA or AG genotype in the gene encoding TNF α;
the +2151 G/C GO genotype in the gene encoding ADAM 33;
the Tyr 113 His T/C (Exon3) CC genotype in the gene encoding MEH; or
the E469K A/G AA genotype in the gene encoding ICAM1;
   may be indicative of an increased risk of developing asthma.

The methods of the invention are particularly useful in smokers (both current and former).

It will be appreciated that the methods of the invention identify two categories of polymorphisms—namely those associated with a reduced risk of developing asthma (which can be termed “protective polymorphisms”) and those associated with an increased risk of developing asthma (which can be termed “susceptibility polymorphisms”).

Therefore, the present invention further provides a method of assessing a subject's risk of developing asthma, said method comprising:

determining the presence or absence of at least one protective polymorphism associated with a reduced risk of developing asthma; and

in the absence of at least one protective polymorphism, determining the presence or absence of at least one susceptibility polymorphism associated with an increased risk of developing asthma;

wherein the presence of one or more of said protective polymorphisms is indicative of a reduced risk of developing asthma, and the absence of at least one protective polymorphism in combination with the presence of at least one susceptibility polymorphism is indicative of an increased risk of developing asthma.

Preferably, said at least one protective polymorphism is selected from the group consisting of:
the Ile 105 Val A/G AA genotype in the gene encoding GSTP1;
the +489 G/A GG genotype in the gene encoding TNF α;
the −159 C/T CC genotype in the gene encoding CD14;
the +2151 G/C CC or CG genotype in the gene encoding ADAM 33; or
the −403 C/T TT genotype in the gene encoding RANTES.

The at least one susceptibility polymorphism may be selected from the group consisting of:
the Arg 197 Gln A/G AA genotype in the gene encoding NAT2;
the +489 G/A AA or AG genotype in the gene encoding TNF α;
the +2151 G/C GG genotype in the gene encoding ADAM 33;
the Tyr 113 His T/C (Exon3) CC genotype in the gene encoding MEH; or
the E469K A/G AA genotype in the gene encoding ICAM1.

In a preferred form of the invention the presence of two or more protective polymorphisms is indicative of a reduced risk of developing asthma.

In a further preferred form of the invention the presence of two or more susceptibility polymorphisms is indicative of an increased risk of developing asthma.

In still a further preferred form of the invention the presence of two or more protective polymorphisms irrespective of the presence of one or more susceptibility polymorphisms is indicative of reduced risk of developing asthma.

In another aspect, the invention provides a method of determining a subject's risk of developing asthma, said method comprising providing the result of one or more genetic tests of a sample from said subject, and analysing the result for the presence or absence of one or more polymorphisms selected from the group consisting of:
+489 G/A in the gene encoding Tissue Necrosis Factor α;
Tyr 113 His T/C (Exon3) in the gene encoding Microsomal epoxide hydrolase; or
one or more polymorphisms in linkage disequilibrium with any one or more of these polymorphisms;

wherein a result indicating the presence or absence of one or more of said polymorphisms is indicative of the subject's risk of developing asthma.

The genetic test is one that is informative of the identity of the allele or genotype at the polymorphic site. The method can additionally comprise analysing the result for the presence or absence of one or more further polymorphisms selected from the group consisting of:
Ile 105 Val A/G in the gene encoding Glutathione S Transferase P (GSTP1);
Arg 197 Gln A/G in the gene encoding N-acetyltransferase 2 (NAT2);
−159 C/T in the gene encoding CD14;
+2151 G/C in the gene encoding ADAM 33;
−403 C/T in the gene encoding RANTES;
E469K A/G in the gene encoding Intra-cellular adhesion molecule (ICAM1); or
one or more polymorphisms in linkage disequilibrium with any one or more of these polymorphisms.
Preferably the genetic test is a method comprising the analysis of one or more polymorphisms as described above.

In a further aspect there is provided a method of determining a subject's risk of developing asthma comprising analysing a sample from said subject for the presence or absence of two or more polymorphisms selected from the group consisting of:
Ile 105 Val A/G in the gene encoding Glutathione S Transferase P;
Arg 197 Gln A/G in the gene encoding N-acetyltransferase 2;
+489 0/A in the gene encoding Tissue Necrosis Factor α;
−159 C/T in the gene encoding CD14;
+2151 G/C in the gene encoding ADAM 33;
−403 C/T in the gene encoding RANTES;
Tyr 113 His T/C (Exon3) in the gene encoding Microsomal epoxide hydrolase;
E469K A/G in the gene encoding Intra-cellular adhesion molecule; or
one or more polymorphisms in linkage disequilibrium with any one or more of these polymorphisms.

In various embodiments, any one or more of the above methods comprises the step of analysing the amino acid present at a position mapping to codon 105 in the gene encoding Glutathione S Transferase P.

In various embodiments, any one or more of the above methods comprises the step of analysing the amino acid present at a position mapping to codon 197 in the gene encoding NAT2.

In various embodiments, any one or more of the above methods comprises the step of analysing the amino acid present at a position mapping to codon 113 in the gene encoding Microsomal epoxide hydrolase.

In various embodiments, any one or more of the above methods comprises the step of analysing the amino acid present at a position mapping to codon 469 in the gene encoding Intra-cellular adhesion molecule.

In a preferred form of the invention the methods as described herein are performed in conjunction with an analysis of one or more risk factors, including one or more epidemiological risk factors, associated with a risk of developing asthma. Such epidemiological risk factors include but are not limited to smoking or exposure to tobacco smoke, age, sex, and familial history of asthma.

In a further aspect, the invention provides for the use of at least one polymorphism in the assessment of a subject's risk of developing asthma, wherein said at least one polymorphism is selected from the group consisting of:
+489 G/A in the gene encoding Tissue Necrosis Factor α;
Tyr 113 His T/C (Exon3) in the gene encoding Microsomal epoxide hydrolase; or
one or more polymorphisms in linkage disequilibrium with any one of said polymorphisms.

The use may be in conjunction with the use of at least one further polymorphism selected from the group consisting of:
Ile 105 Val A/G in the gene encoding Glutathione S Transferase P;
Arg 197 Gln A/G in the gene encoding N-acetyltransferase 2;
−159 C/T in the gene encoding CD14;
+2151 G/C in the gene encoding ADAM 33;
−403 C/T in the gene encoding RANTES;
E469K A/G in the gene encoding Intra-cellular adhesion molecule; or one or more polymorphisms in linkage disequilibrium with any one of said polymorphisms,

In another aspect the invention provides a set of nucleotide probes and/or primers for use in the preferred methods of the invention herein described. Preferably, the nucleotide probes and/or primers are those which span, or are able to be used to span, the polymorphic regions of the genes. Also provided are one or more nucleotide probes and/or primers comprising the sequence of any one of the probes and/or primers herein described, including any one comprising the sequence of any one of SEQ.ID.NO. 1 to 40.

In yet a further aspect, the invention provides a nucleic acid microarray for use in the methods of the invention, which microarray comprises a substrate presenting nucleic acid sequences capable of hybridizing to nucleic acid sequences which encode one or more of the susceptibility or protective polymorphisms described herein or sequences complimentary thereto.

In another aspect, the invention provides an antibody microarray for use in the methods of the invention, which microarray comprises a substrate presenting antibodies capable of binding to a product of expression of a gene the expression of which is upregulated or downregulated when associated with a susceptibility or protective polymorphism as described herein.

In a further aspect the present invention provides a method treating a subject having an increased risk of developing asthma comprising the step of replicating, genotypically or phenotypically, the presence and/or functional effect of a protective polymorphism in said subject.

In yet a further aspect, the present invention provides a method of treating a subject having an increased risk of developing asthma, said subject having a detectable susceptibility polymorphism which either upregulates or downregulates expression of a gene such that the physiologically active concentration of the expressed gene product is outside a range which is normal for the age and sex of the subject, said method comprising the step of restoring the physiologically active concentration of said product of gene expression to be within a range which is normal for the age and sex of the subject.

In yet a further aspect, the present invention provides a method for screening for compounds that modulate the expression and/or activity of a gene, the expression of which is upregulated or downregulated when associated with a susceptibility or protective polymorphism, said method comprising the steps of:

contacting a candidate compound with a cell comprising a susceptibility or protective polymorphism which has been determined to be associated with the upregulation or downregulation of expression of a gene; and

measuring the expression of said gene following contact with said candidate compound,

wherein a change in the level of expression after the contacting step as compared to before the contacting step is indicative of the ability of the compound to modulate the expression and/or activity of said gene.

Preferably, said cell is a human lung cell which has been pre-screened to confirm the presence of said polymorphism.

Preferably, said cell comprises a susceptibility polymorphism associated with upregulation of expression of said gene and said screening is for candidate compounds which downregulate expression of said gene.

Alternatively, said cell comprises a susceptibility polymorphism associated with downregulation of expression of said gene and said screening is for candidate compounds which upregulate expression of said gene.

In another embodiment, said cell comprises a protective polymorphism associated with upregulation of expression of said gene and said screening is for candidate compounds which further upregulate expression of said gene.

Alternatively, said cell comprises a protective polymorphism associated with downregulation of expression of said gene and said screening is for candidate compounds which further downregulate expression of said gene.

In another aspect, the present invention provides a method for screening for compounds that modulate the expression and/or activity of a gene, the expression of which is upregulated or downregulated when associated with a susceptibility or protective polymorphism, said method comprising the steps of:

contacting a candidate compound with a cell comprising a gene, the expression of which is upregulated or downregulated when associated with a susceptibility or protective polymorphism but which in said cell the expression of which is neither upregulated nor downregulated; and

measuring the expression of said gene following contact with said candidate compound,

wherein a change in the level of expression after the contacting step as compared to before the contacting step is indicative of the ability of the compound to modulate the expression and/or activity of said gene.

Preferably, expression of the gene is downregulated when associated with a susceptibility polymorphism once said screening is for candidate compounds which in said cell, upregulate expression of said gene.

Preferably, said cell is a human lung cell which has been pre-screened to confirm the presence, and baseline level of expression, of said gene.

Alternatively, expression of the gene is upregulated when associated with a susceptibility polymorphism and said screening is for candidate compounds which, in said cell, downregulate expression of said gene.

In another embodiment, expression of the gene is upregulated when associated with a protective polymorphism and said screening is for compounds which, in said cell, upregulate expression of said gene.

Alternatively, expression of the gene is downregulated when associated with a protective polymorphism and said screening is for compounds which, in said cell, downregulate expression of said gene.

In yet a further aspect, the present invention provides a method of assessing the likely responsiveness of a subject at risk of developing or suffering from asthma to a prophylactic or therapeutic treatment, which treatment involves restoring the physiologically active concentration of a product of gene expression to be within a range which is normal for the age and sex of the subject, which method comprises detecting in said subject the presence or absence of a susceptibility polymorphism which when present either upregulates or downregulates expression of said gene such that the physiological active concentration of the expressed gene product is outside said normal range, wherein the detection of the presence of said polymorphism is indicative of the subject likely responding to said treatment.

In a further aspect, the present invention provides a kit for assessing a subject's risk of developing asthma, said kit comprising an analytical reagent for analysing a sample from said subject for the presence or absence of one or more polymorphisms disclosed herein.

### BRIEF DESCRIPTION OF FIGURES

FIG. 1: depicts a graph showing the percentage of subjects with asthma plotted against the combined SNP score, as described in Example 1 herein.

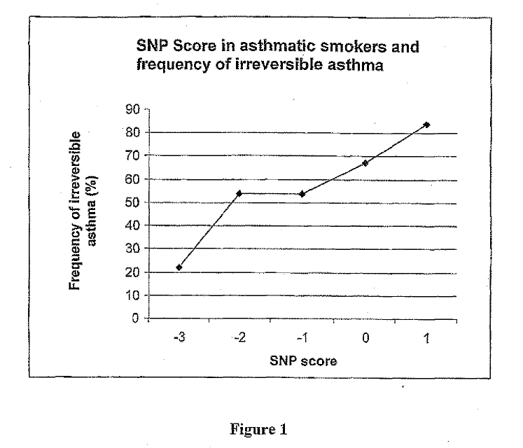

### DESCRIPTION OF THE PREFERRED EMBODIMENTS

Using case-control studies the frequencies of several genetic variants (polymorphisms) of candidate genes in smokers who have developed asthma, resistant smokers, and blood donor controls have been compared. The majority of these candidate genes have confirmed (or likely) functional effects on gene expression or protein function. Specifically the frequencies of polymorphisms between blood donor controls, resistant smokers and those with asthma (subdivided into those with early onset and those with normal onset) have been compared. The present invention demonstrates that there are both protective and susceptibility polymorphisms present in selected candidate genes of the patients tested.

In one embodiment described herein 5 susceptibility genetic polymorphisms and 5 protective genetic polymorphisms are identified. These are as follows:

| Gene | Polymorphism | Genotype | Role |
|---|---|---|---|
| Glutathione S | GSTP1 Ile 105 Val A/G | AA | protective |
| Transferase P | | | |
| N-acetyltransferase | NAT2 Arg197Gln A/G | AA | susceptibility |
| 2 (NAT2) | | | |
| Tissue Necrosis | TNF α +489 G/A | AA/AG | susceptibility |
| Factor α | | GG | protective |
| CD14 | CD-14 −159 C/T | CC | protective |
| ADAM 33 | ADAM 33 +2151G/C | CC/CG | protective |
| | | GG | susceptibility |
| RANTES | RANTES −403 C/T | TT | protective |
| Microsomal epoxids | MEH Tyr 113 His T/C | GC | susceptibility |
| hydrolase (MBH) | (Exon3) | | |
| Intra-cellular | ICAM-1 E469K A/G | AA | susceptibility |
| adhesion molecule | | | |
| (ICAM1) | | | |

A susceptibility genetic polymorphism is one which, when present, is indicative of an increased risk of developing asthma. In contrast, a protective genetic polymorphism is one which, when present, is indicative of a reduced risk of developing asthma.

As used herein, the phrase “risk of developing asthma” means the likelihood that a subject to whom the risk applies will develop asthma, and includes predisposition to, and potential onset of the disease. Accordingly, the phrase “increased risk of developing asthma” means that a subject having such an increased risk possesses an hereditary inclination or tendency to develop asthma. This does not mean that such a person will actually develop asthma at any time, merely that he or she has a greater likelihood of developing asthma compared to the general population of individuals that either does not possess a polymorphism associated with increased asthma or does possess a polymorphism associated with decreased asthma risk. Subjects with an increased risk of developing asthma include those with a predisposition to asthma, such as a tendency or predilection regardless of their lung function at the time of assessment, for example, a subject who is genetically inclined to asthma but who has normal lung function, those at potential risk, including subjects with a tendency to mildly reduced lung function who are likely to go on to suffer asthma if they keep smoking, and subjects with potential onset of asthma, who have a tendency to poor lung function on spirometry etc., consistent with asthma at the time of assessment.

Similarly, the phrase “decreased risk of developing asthma” means that a subject having such a decreased risk possesses an hereditary disinclination or reduced tendency to develop asthma. This does not mean that such a person will not develop asthma at any time, merely that he or she has a decreased likelihood of developing asthma compared to the general population of individuals that either does possess one or more polymorphisms associated with increased asthma, or does not possess a polymorphism associated with decreased asthma.

It will be understood that in the context of the present invention the term “polymorphism” means the occurrence together in the same population at a rate greater than that attributable to random mutation (usually greater than 1%) of two or more alternate forms (such as alleles or genetic markers) of a chromosomal locus that differ in nucleotide sequence or have variable numbers of repeated nucleotide units. See www.ornl.gov/sci/techresources/Human_Genome/publicat/97pr/09gloss.html#p. Accordingly, the term “polymorphisms” is used herein contemplates genetic variations, including single nucleotide substitutions, insertions and deletions of nucleotides, repetitive sequences (such as microsatellites), and the total or partial absence of genes (eg. null mutations). As used herein, the term “polymorphisms” also includes genotypes and haplotypes. A genotype is the genetic composition at a specific locus or set of loci. A haplotype is a set of closely linked genetic markers present on one chromosome which are not easily separable by recombination, tend to be inherited together, and may be in linkage disequilibrium. A haplotype can be identified by patterns of polymorphisms such as single nucleotide polymorphisms (SNPs). Similarly, the term “single nucleotide polymorphism” or “SNP” in the context of the present invention includes single base nucleotide substitutions and short deletion and insertion polymorphisms.

A reduced or increased risk of a subject developing asthma may be diagnosed by analysing a sample from said subject for the presence of a polymorphism selected from the group consisting of:
+489 G/A in the gene encoding Tissue Necrosis Factor α;
Tyr 113 His T/C (Exon3) in the gene encoding Microsomal epoxide hydrolase;
or one or more polymorphisms which are in linkage disequilibrium with any one or more of the above group.

The diagnosis may additionally comprise analysing a sample from said subject for the presence or absence of one or more further polymorphisms selected from the group consisting of:
Ile 105 Val A/G in the gene encoding Glutathione S Transferase P;
Arg 197 Gln A/G in the gene encoding N-acetyltransferase 2;
−159 C/T in the gene encoding CD14;
+2151 G/C in the gene encoding ADAM 33;
−403 C/T in the gene encoding RANTES;
E469K A/G in the gene encoding Intra-cellular adhesion molecule;
or one or more polymorphisms which are in linkage disequilibrium with any one or more of the above group.

These polymorphisms can also be analysed in combinations of two or more, or in combination with other polymorphisms indicative of a subject's risk of developing asthma inclusive of the remaining polymorphisms listed above.

Expressly contemplated are combinations of the above polymorphisms with polymorphisms as described in PCT International application PCT/NZ02/00106, published as WO 02/099134.

Assays which involve combinations of polymorphisms, including those amenable to high throughput, such as those utilising microarrays, are preferred.

Statistical analyses, particularly of the combined effects of these polymorphisms, show that the genetic analyses of the present invention can be used to determine the risk quotient of any smoker and in particular to identify smokers at greater risk of developing asthma. Such combined analysis can be of combinations of susceptibility polymorphisms only, of protective polymorphisms only, or of combinations of both. Analysis can also be step-wise, with analysis of the presence or absence of protective polymorphisms occurring first and then with analysis of susceptibility polymorphisms proceeding only where no protective polymorphisms are present.

Thus, through systematic analysis of the frequency of these polymorphisms in well defined groups of smokers and non-smokers, as described herein, it is possible to implicate certain proteins in the development of asthma and improve the ability to identify which smokers are at increased risk of developing asthma-related impaired lung function and asthma for predictive purposes.

The present results show for the first time that the minority of smokers who develop asthma do so because they have one or more of the susceptibility polymorphisms and few or none of the protective polymorphisms defined herein. It is thought that the presence of one or more susceptibility polymorphisms, together with the damaging irritant and oxidant effects of smoking, combine to make this group of smokers highly susceptible to developing asthma. Additional risk factors, such as familial history, age, weight, pack years, etc., will also have an impact on the risk profile of a subject, and can be assessed in combination with the genetic analyses described herein.

The one or more polymorphisms can be detected directly or by detection of one or more polymorphisms which are in linkage disequilibrium with said one or more polymorphisms. As discussed above, linkage disequilibrium is a phenomenon in genetics whereby two or more mutations or polymorphisms are in such close genetic proximity that they are co-inherited. This means that in genotyping, detection of one polymorphism as present infers the presence of the other. (Reich D E et al; Linkage disequilibrium in the human genome, Nature 2001, 411:199-204.)

It will be apparent that polymorphisms in linkage disequilibrium with one or more other polymorphism associated with increased or decreased risk of developing asthma will also provide utility as biomarkers for risk of developing asthma. The frequency for SNPs in linkage disequilibrium is expected to be very similar. Accordingly, genetically linked SNPs can be utilized in combined polymorphism analyses to derive a level of risk comparable to that calculated from the original SNP.

It will therefore be apparent that one or more polymorphisms in linkage disequilibrium with the polymorphisms specified herein can be identified, for example, using public data bases. Examples of such polymorphisms reported to be in linkage disequilibrium with the polymorphisms specified herein are presented herein in Table 16.

It will also be apparent that frequently a variety of nomenclatures may exist for any given polymorphism. When referring to a susceptibility or protective polymorphism as herein described, such alternative nomenclatures are also contemplated by the present invention.

The methods of the invention are primarily directed to the detection and identification of the above polymorphisms associated with asthma, which are all single nucleotide polymorphisms. In general terms, a single nucleotide polymorphism (SNP) is a single base change or point mutation resulting in genetic variation between individuals. SNPs occur in the human genome approximately once every 100 to 300 bases, and can occur in coding or non-coding regions. Due to the redundancy of the genetic code, a SNP in the coding region may or may not change the amino acid sequence of a protein product. A SNP in a non-coding region can, for example, alter gene expression by, for example, modifying control regions such as promoters, transcription factor binding sites, processing sites, ribosomal binding sites, and affect gene transcription, processing, and translation.

SNPs can facilitate large-scale association genetics studies, and there has recently been great interest in SNP discovery and detection. SNPs show great promise as markers for a number of phenotypic traits (including latent traits), such as for example, disease propensity and severity, wellness propensity, and drug responsiveness including, for example, susceptibility to adverse drug reactions. Knowledge of the association of a particular SNP with a phenotypic trait, coupled with the knowledge of whether an individual has said particular SNP, can enable the targeting of diagnostic, preventative and therapeutic applications to allow better disease management, to enhance understanding of disease states and to ultimately facilitate the discovery of more effective treatments, such as personalised treatment regimens.

Indeed, a number of databases have been constructed of known SNPs, and for some such SNPs, the biological effect associated with a SNP. For example, the NCBI SNP database “dbSNP” is incorporated into NCBI's Entrez system and can be queried using the same approach as the other Entrez databases such as PubMed and GenBank. This database has records for over 1.5 million SNPs mapped onto the human genome sequence. Each dbSNP entry includes the sequence context of the polymorphism (i.e., the surrounding sequence), the occurrence frequency of the polymorphism (by population or individual), and the experimental method(s), protocols, and conditions used to assay the variation, and can include information associating a SNP with a particular phenotypic trait.

At least in part because of the potential impact on health and wellness, there has been and continues to be a great deal of effort to develop methods that reliably and rapidly identify SNPs. This is no trivial task, at least in part because of the complexity of human genomic DNA, with a haploid genome of 3×10⁹ base pairs, and the associated sensitivity and discriminatory requirements.

Genotyping approaches to detect SNPs well-known in the art include DNA sequencing, methods that require allele specific hybridization of primers or probes, allele specific incorporation of nucleotides to primers bound close to or adjacent to the polymorphisms (often referred to as “single base extension”, or “minisequencing”), allele-specific ligation (joining) of oligonucleotides (ligation chain reaction or ligation padlock probes), allele-specific cleavage of oligonucleotides or PCR products by restriction enzymes (restriction fragment length polymorphisms analysis or RFLP) or chemical or other agents, resolution of allele-dependent differences in electrophoretic or chromatographic mobilities, by structure specific enzymes including invasive structure specific enzymes, or mass spectrometry. Analysis of amino acid variation is also possible where the SNP lies in a coding region and results in an amino acid change.

DNA sequencing allows the direct determination and identification of SNPs. The benefits in specificity and accuracy are generally outweighed for screening purposes by the difficulties inherent in whole genome, or even targeted subgenome, sequencing.

Mini-sequencing involves allowing a primer to hybridize to the DNA sequence adjacent to the SNP site on the test sample under investigation. The primer is extended by one nucleotide using all four differentially tagged fluorescent dideoxynucleotides (A,C,G, or T), and a DNA polymerase. Only one of the four nucleotides (homozygous case) or two of the four nucleotides (heterozygous case) is incorporated. The base that is incorporated is complementary to the nucleotide at the SNP position.

A number of methods currently used for SNP detection involve site-specific and/or allele-specific hybridisation. These methods are largely reliant on the discriminatory binding of oligonucleotides to target sequences containing the SNP of interest. The techniques of Affymetrix (Santa Clara, Calif.) and Nanogen Inc. (San Diego, Calif.) are particularly well-known, and utilize the fact that DNA duplexes containing single base mismatches are much less stable than duplexes that are perfectly base-paired. The presence of a matched duplex is detected by fluorescence.

The majority of methods to detect or identify SNPs by site-specific hybridisation require target amplification by methods such as PCR to increase sensitivity and specificity (see, for example U.S. Pat. No. 5,679,524, PCT publication WO 98/59066, PCT publication WO 95/12607). US Application 20050059030 (incorporated by reference herein in its entirety) describes a method for detecting a single nucleotide polymorphism in total human DNA without prior amplification or complexity reduction to selectively enrich for the target sequence, and without the aid of any enzymatic reaction. The method utilises a single-step hybridization involving two hybridization events: hybridization of a first portion of the target sequence to a capture probe, and hybridization of a second portion of said target sequence to a detection probe. Both hybridization events happen in the same reaction, and the order in which hybridisation occurs is not critical.

US Application 20050042608 (incorporated by reference herein in its entirety) describes a modification of the method of electrochemical detection of nucleic acid hybridization of Thorp et al. (U.S. Pat. No. 5,871,918). Briefly, capture probes are designed, each of which has a different SNP base and a sequence of probe bases on each side of the SNP base. The probe bases are complementary to the corresponding target sequence adjacent to the SNP site. Each capture probe is immobilized on a different electrode having a non-conductive outer layer on a conductive working surface of a substrate. The extent of hybridization between each capture probe and the nucleic acid target is detected by detecting the oxidation-reduction reaction at each electrode, utilizing a transition metal complex. These differences in the oxidation rates at the different electrodes are used to determine whether the selected nucleic acid target has a single nucleotide polymorphism at the selected SNP site.

The technique of Lynx Therapeutics (Hayward, Calif.) using MEGATYPE™ technology can genotype very large numbers of SNPs simultaneously from small or large pools of genomic material. This technology uses fluorescently labeled probes and compares the collected genomes of two populations, enabling detection and recovery of DNA fragments spanning SNPs that distinguish the two populations, without requiring prior SNP mapping or knowledge.

A number of other methods for detecting and identifying SNPs exist. These include the use of mass spectrometry, for example, to measure probes that hybridize to the SNP. This technique varies in bow rapidly it can be performed, from a few samples per day to a high throughput of 40,000 SNPs per day, using mass code tags. A preferred example is the use of mass spectrometric determination of a nucleic acid sequence which comprises the polymorphisms of the invention, for example, which includes the promoter of the COX2 gene or a complementary sequence. Such mass spectrometric methods are known to those skilled in the art, and the genotyping methods of the invention are amenable to adaptation for the mass spectrometric detection of the polymorphisms of the invention, for example, the COX2 promoter polymorphisms of the invention. Exemplary methods for mass spectrometric analysis suitable for use in the present invention are disclosed in, for example, U.S. Pat. Nos. 5,547,835, 5,605,798, 6,043,031, 6,074,823, 6,140,053, 6,197,498, 6,221,601, 6,221,605, 6,235,478, 6,258,538, 6,268,131, 6,268,144, 6,277,573, 6,300,076, 6,428,955, 6,602,662, 6,855,500, 6,994,998, 7,198,893, U.S. Ser. No. 11/087,920 (published as US patent application 2006040282), each incorporated by reference herein in its entirety.

SNPs can also be determined by ligation-bit analysis. This analysis requires two primers that hybridize to a target with a one nucleotide gap between the primers. Each of the four nucleotides is added to a separate reaction mixture containing DNA polymerase, ligase, target DNA and the primers. The polymerase adds a nucleotide to the 3′ end of the first primer that is complementary to the SNP, and the ligase then ligates the two adjacent primers together. Upon heating of the sample, if ligation has occurred, the now larger primer will remain hybridized and a signal, for example, fluorescence, can be detected. A further discussion of these methods can be found in U.S. Pat. Nos. 5,919,626; 5,945,283; 5,242,794; and 5,952,174.

U.S. Pat. No. 6,821,733 (incorporated by reference herein in its entirety) describes methods to detect differences in the sequence of two nucleic acid molecules that includes the steps of: contacting two nucleic acids under conditions that allow the formation of a four-way complex and branch migration; contacting the four-way complex with a tracer molecule and a detection molecule under conditions in which the detection molecule is capable of binding the tracer molecule or the four-way complex; and determining binding of the tracer molecule to the detection molecule before and after exposure to the four-way complex. Competition of the four-way complex with the tracer molecule for binding to the detection molecule indicates a difference between the two nucleic acids.

Protein- and proteomics-based approaches are also suitable for polymorphism detection and analysis. Polymorphisms which result in or are associated with variation in expressed proteins can be detected directly by analysing said proteins. This typically requires separation of the various proteins within a sample, by, for example, gel electrophoresis or HPLC, and identification of said proteins or peptides derived therefrom, for example by NMR or protein sequencing such as chemical sequencing or more prevalently mass spectrometry. Proteomic methodologies are well known in the art, and have great potential for automation. For example, integrated systems, such as the ProteomIQ™ system from Proteome Systems, provide high throughput platforms for proteome analysis combining sample preparation, protein separation, image acquisition and analysis, protein processing, mass spectrometry and bioinformatics technologies.

The majority of proteomic methods of protein identification utilise mass spectrometry, including ion trap mass spectrometry, liquid chromatography (LC) and LC/MSn mass spectrometry, gas chromatography (GC) mass spectroscopy, Fourier transform-ion cyclotron resonance-mass spectrometer (FT-MS), MALDI-TOF mass spectrometry, and ESI mass spectrometry, and their derivatives. Mass spectrometric methods are also useful in the determination of post-translational modification of proteins, such as phosphorylation or glycosylation, and thus have utility in determining polymorphisms that result in or are associated with variation in post-translational modifications of proteins. Exemplary methods for mass spectrometric analysis suitable for use in the present invention are disclosed in, for example, U.S. Pat. Nos. 6,558,902, 6,387,628, 6,322,970, and 6,207,370, each incorporated by reference herein in its entirety.

Associated technologies are also well known, and include, for example, protein processing devices such as the “Chemical Inkjet Printer” comprising piezoelectric printing technology that allows in situ enzymatic or chemical digestion of protein samples electroblotted from 2-D PAGE gels to membranes by jetting the enzyme or chemical directly onto the selected protein spots. After in-situ digestion and incubation of the proteins, the membrane can be placed directly into the mass spectrometer for peptide analysis.

A large number of methods reliant on the conformational variability of nucleic acids have, been developed to detect SNPs.

For example, Single Strand Conformational Polymorphism (SSCP, Orita et al., PNAS 1989 86:2766-2770) is a method reliant on the ability of single-stranded nucleic acids to form secondary structure in solution under certain conditions. The secondary structure depends on the base composition and can be altered by a single nucleotide substitution, causing differences in electrophoretic mobility under nondenaturing conditions. The various polymorphs are typically detected by autoradiography when radioactively labelled, by silver staining of bands, by hybridisation with detectably labelled probe fragments or the use of fluorescent PCR primers which are subsequently detected, for example by an automated DNA sequencer.

Modifications of SSCP are well known in the art, and include the use of differing gel running conditions, such as for example differing temperature, or the addition of additives, and different gel matrices. Other variations on SSCP are well known to the skilled artisan, including, RNA-SSCP, restriction endonuclease fingerprinting-SSCP, dideoxy fingerprinting (a hybrid between dideoxy sequencing and SSCP), bi-directional dideoxy fingerprinting (in which the dideoxy termination reaction is performed simultaneously with two opposing primers), and Fluorescent PCR-SSCP (in which PCR products are internally labelled with multiple fluorescent dyes, may be digested with restriction enzymes, followed by SSCP, and analysed on an automated DNA sequencer able to detect the fluorescent dyes).

Other methods which utilise the varying mobility of different nucleic acid structures include Denaturing Gradient Gel Electrophoresis (DGGE), Temperature Gradient Gel Electrophoresis (TGGE), and Heteroduplex Analysis (HET). Here, variation in the dissociation of double stranded DNA (for example, due to base-pair mismatches) results in a change in electrophoretic inability. These mobility shifts are used to detect nucleotide variations.

Denaturing High Pressure Liquid Chromatography (HPLC) is yet a further method utilised to detect SNPs, using HPLC methods well-known in the art as an alternative to the separation methods described above (such as gel electophoresis) to detect, for example, homoduplexes and heteroduplexes which elute from the HPLC column at different rates, thereby enabling detection of mismatch nucleotides and thus SNPs.

Yet further methods to detect SNPs rely on the differing susceptibility of single stranded and double stranded nucleic acids to cleavage by various agents, including chemical cleavage agents and nucleolytic enzymes. For example, cleavage of mismatches within RNA:DNA heteroduplexes by RNase A, of heteroduplexes by, for example bacteriophage T4 endonuclease YII or T7 endonuclease I, of the 5′ end of the hairpin loops at the junction between single stranded and double stranded DNA by cleavase I, and the modification of mispaired nucleotides within heteroduplexes by chemical agents commonly used in Maxam-Gilbert sequencing chemistry, are all well known in the art.

Further examples include the Protein Translation Test (PTT), used to resolve stop codons generated by variations which lead to a premature termination of translation and to protein products of reduced size, and the use of mismatch binding proteins. Variations are detected by binding of, for example, the MutS protein, a component of Escherichia coli DNA mismatch repair system, or the human hMSH2 and GTBP proteins, to double stranded DNA heteroduplexes containing mismatched bases. DNA duplexes are then incubated with the mismatch binding protein, and variations are detected by mobility shift assay. For example, a simple assay is based on the fact that the binding of the mismatch binding protein to the heteroduplex protects the heteroduplex from exonuclease degradation.

Those skilled in the art will know that a particular SNP, particularly when it occurs in a regulatory region of a gene such as a promoter, can be associated with altered expression of a gene. Altered expression of a gene can also result when the SNP is located in the coding region of a protein-encoding gene, for example where the SNP is associated with codons of varying usage and thus with tRNAs of differing abundance. Such altered expression can be determined by methods well known in the art, and can thereby be employed to detect such SNPs. Similarly, where a SNP occurs in the coding region of a gene and results in a nonsynonomous amino acid substitution, such substitution can result in a change in the function of the gene product. Similarly, in cases where the gene product is an RNA, such SNPs can result in a change of function in the RNA gene product. Any such change in function, for example as assessed in an activity or functionality assay, can be employed to detect such SNPs.

The above methods of detecting and identifying SNPs are amenable to use in the methods of the invention.

Of course, in order to detect and identify SNPs in accordance with the invention, a sample containing material to be tested is obtained from the subject. The sample can be any sample potentially containing the target SNPs (or target polypeptides, as the case may be) and obtained from any bodily fluid (blood, urine, saliva, etc) biopsies or other tissue preparations.

DNA or RNA can be isolated from the sample according to any of a number of methods well known in the art. For example, methods of purification of nucleic acids are described in Tijssen; Laboratory Techniques in Biochemistry and Molecular Biology: Hybridization with nucleic acid probes Part 1: Theory and Nucleic acid preparation, Elsevier, New York, N.Y. 1993, as well as in Maniatis, T., Fritsch, E. F. and Sambrook, Molecular Cloning Manual 1989.

To assist with detecting the presence or absence of polymorphisms/SNPs, nucleic acid probes and/or primers can be provided. Such probes have nucleic acid sequences specific for chromosomal changes evidencing the presence or absence of the polymorphism and are preferably labeled with a substance that emits a detectable signal when combined with the target polymorphism.

The nucleic acid probes can be genomic DNA or cDNA or mRNA, or any RNA-like or DNA-like material, such as peptide nucleic acids, branched DNAs, and the like. The probes can be sense or antisense polynucleotide probes. Where target polynucleotides are double-stranded, the probes may be either sense or antisense strands. Where the target polynucleotides are single-stranded, the probes are complementary single strands.

The probes can be prepared by a variety of synthetic or enzymatic schemes, which are well known in the art. The probes can be synthesized, in whole or in part, using chemical methods well known in the art (Caruthers et al., Nucleic Acids Res., Symp. Ser., 215-233 (1980)). Alternatively, the probes can be generated, in whole or in part, enzymatically.

Nucleotide analogs can be incorporated into probes by methods well known in the art. The only requirement is that the incorporated nucleotide analog must serve to base pair with target polynucleotide sequences. For example, certain guanine nucleotides can be substituted with hypoxanthine, which base pairs with cytosine residues. However, these base pairs are less stable than those between guanine and cytosine. Alternatively, adenine nucleotides can be substituted with 2,6-diaminopurine, which can form stronger base pairs than those between adenine and thymidine.

Additionally, the probes can include nucleotides that have been derivatized chemically or enzymatically. Typical chemical modifications include derivatization with acyl, alkyl, aryl or amino groups.

The probes can be immobilized on a substrate. Preferred substrates are any suitable rigid or semi-rigid support including membranes, filters, chips, slides, wafers, fibers, magnetic or nonmagnetic beads, gels, tubing, plates, polymers, microparticles and capillaries. The substrate can have a variety of surface forms, such as wells, trenches, pins, channels and pores, to which the polynucleotide probes are bound. Preferably, the substrates are optically transparent.

Furthermore, the probes do not have to be directly bound to the substrate, but rather can be bound to the substrate through a linker group. The linker groups are typically about 6 to 50 atoms long to provide exposure to the attached probe. Preferred linker groups include ethylene glycol oligomers, diamines, diacids and the like. Reactive groups on the substrate surface react with one of the terminal portions of the linker to bind the linker to the substrate. The other terminal portion of the linker is then functionalized for binding the probe.

The probes can be attached to a substrate by dispensing reagents for probe synthesis on the substrate surface or by dispensing preformed DNA fragments or clones on the substrate surface. Typical dispensers include a micropipette delivering solution to the substrate with a robotic system to control the position of the micropipette with respect to the substrate. There can be a multiplicity of dispensers so that reagents can be delivered to the reaction regions simultaneously.

Nucleic acid microarrays are preferred. Such microarrays (including nucleic acid chips) are well known in the art (see, for example U.S. Pat. Nos. 5,578,832; 5,861,242; 6,183,698; 6,287,850; 6,291,183; 6,297,018; 6,306,643; and 6,308,170, each incorporated by reference).

Alternatively, antibody microarrays can be produced. The production of such microarrays is essentially as described in Schweitzer & Kingsmore, “Measuring proteins on microarrays”, Curr Opin Biotechnol 2002; 13(1): 14-9; Avseekno at al., “Immobilization of proteins in immunochemical microarrays fabricated by electrospray deposition”, Anal Chem 2001 15; 73(24): 6047-52; Huang, “Detection of multiple proteins in an antibody-based protein microarray system, Immunol Methods 2001 1; 255 (1-2): 1-13.

The present invention also contemplates the preparation of kits for use in accordance with the present invention. Suitable kits include various reagents for use in accordance with the present invention in suitable containers and packaging materials, including tubes, vials, and shrink-wrapped and blow-molded packages.

Materials suitable for inclusion in an exemplary kit in accordance with the present invention comprise one or more of the following: gene specific PCR primer pairs (oligonucleotides) that anneal to DNA or cDNA sequence domains that flank the genetic polymorphisms of interest, reagents capable of amplifying a specific sequence domain in either genomic DNA or cDNA without the requirement of performing PCR; reagents required to discriminate between the various possible alleles in the sequence domains amplified by PCR or non-PCR amplification (e.g., restriction endonucleases, oligonucleotide that anneal preferentially to one allele of the polymorphism, including those modified to contain enzymes or fluorescent chemical groups that amplify the signal from the oligonucleotide and make discrimination of alleles more robust); reagents required to physically separate products derived from the various alleles (e.g. agarose or polyacrylamide and a buffer to be used in electrophoresis, HPLC columns, SSCP gels, formamide gels or a matrix support for MALDI-TOF).

It will be appreciated that the methods of the invention can be performed in conjunction with an analysis of other risk factors known to be associated with asthma. Such risk factors include epidemiological risk factors associated with an increased risk of developing asthma. Such risk factors include, but are not limited to smoking and/or exposure to tobacco smoke, age, sex and familial history. These risk factors can be used to augment an analysis of one or more polymorphisms as herein described when assessing a subject's risk of developing asthma.

The predictive methods of the invention allow a number of therapeutic interventions and/or treatment regimens to be assessed for suitability and implemented for a given subject. The simplest of these can be the provision to the subject of motivation to implement a lifestyle change, for example, where the subject is a current smoker, the methods of the invention can provide motivation to quit smoking.

The manner of therapeutic intervention or treatment will be predicated by the nature of the polymorphism(s) and the biological effect of said polymorphism(s). For example, where a susceptibility polymorphism is associated with a change in the expression of a gene, intervention or treatment is preferably directed to the restoration of normal expression of said gene, by, for example, administration of an agent capable of modulating the expression of said gene. Where a polymorphism is associated with decreased expression of a gene, therapy can involve administration of an agent capable of increasing the expression of said gene, and conversely, where a polymorphism is associated with increased expression of a gene, therapy can involve administration of an agent capable of decreasing the expression of said gene. Methods useful for the modulation of gene expression are well known in the art. For example, in situations where a polymorphism is associated with upregulated expression of a gene, therapy utilising, for example, RNAi or antisense methodologies can be implemented to decrease the abundance of mRNA and so decrease the expression of said gene. Alternatively, therapy can involve methods directed to, for example, modulating the activity of the product of said gene, thereby compensating for the abnormal expression of said gene.

Where a susceptibility polymorphism is associated with decreased gene product function or decreased levels of expression of a gene product, therapeutic intervention or treatment can involve augmenting or replacing of said function, or supplementing the amount of gene product within the subject for example, by administration of said gene product or a functional analogue thereof. For example, where a polymorphism is associated with decreased enzyme function, therapy can involve administration of active enzyme or an enzyme analogue to the subject. Similarly, where a polymorphism is associated with increased gene product function, therapeutic intervention or treatment can involve reduction of said function, for example, by administration of an inhibitor of said gene product or an agent capable of decreasing the level of said gene product in the subject. For example, where a SNP allele or genotype is associated with increased enzyme function, therapy can involve administration of an enzyme inhibitor to the subject.

Likewise, when a protective polymorphism is associated with upregulation of a particular gene or expression of an enzyme or other protein, therapies can be directed to mimic such upregulation or expression in an individual lacking the resistive genotype, and/or delivery of such enzyme or other protein to such individual. Further, when a protective polymorphism is associated with downregulation of a particular gene, or with diminished or eliminated expression of an enzyme or other protein, desirable therapies can be directed to mimicking such conditions in an individual that lacks the protective genotype.

The relationship between the various polymorphisms identified above and the susceptibility (or otherwise) of a subject to asthma also has application in the design and/or screening of candidate therapeutics. This is particularly the case where the association between a susceptibility or protective polymorphism is manifested by either an upregulation or downregulation of expression of a gene. In such instances, the effect of a candidate therapeutic on such upregulation or downregulation is readily detectable.

For example, in one embodiment existing human lung organ and cell cultures are screened for polymorphisms as set forth above. (For information on human lung organ and cell cultures, see, e.g.: Bohinski et al. (1996) Molecular and Cellular Biology 14:5671-5681; Collettsolberg et al. (1996) Pediatric Research 39:504; Hermanns et al. (2004) Laboratory Investigation 84:736-752; Hume et al. (1996) In Vitro Cellular & Developmental Biology-Animal 32:24-29; Leonardi et al. (1995) 38:352-355; Notiugher et al. (2003) Biopolymers (Biospectroscopy) 72:230-240; Ohga et al. (1996) Biochemical and Biophysical Research Communications 228:391-396; each of which is hereby incorporated by reference in its entirety.) Cultures representing susceptibility and protective genotype groups are selected, together with cultures which are putatively “normal” in terms of the expression of a gene which is either upregulated or downregulated where a protective polymorphism is present.

Samples of such cultures are exposed to a library of candidate therapeutic compounds and screened for any or all of: (a) downregulation of susceptibility genes that are normally upregulated in susceptibility polymorphisms; (b) upregulation of susceptibility genes that are normally downregulated in susceptibility polymorphisms; (c) downregulation of protective genes that are normally downregulated or not expressed (or null forms are expressed) in protective polymorphisms; and (d) upregulation of protective genes that are normally upregulated in protective polymorphisms. Compounds are selected for their ability to alter the regulation and/or action of susceptibility genes and/or protective genes in a culture having a susceptibility polymorphisms.

Similarly, where the polymorphism is one which when present results in a physiologically active concentration of an expressed gene product outside of the normal range for a subject (adjusted for age and sex), and where there is an available prophylactic or therapeutic approach to restoring levels of that expressed gene product to within the normal range, individual subjects can be screened to determine the likelihood of their benefiting from that restorative approach. Such screening involves detecting the presence or absence of the polymorphism in the subject by any of the methods described herein, with those subjects in which the polymorphism is present being identified as individuals likely to benefit from treatment.

The invention will now be described in more detail, with reference to non-limiting examples.

### EXAMPLE 1

### Case Association Study

### Introduction

Case-control association studies allow the careful selection of a control group where matching for important risk factors is critical. In this study, smokers diagnosed with asthma and smokers without asthma with normal lung function were compared. This unique control group is highly relevant as it is impossible to pre-select smokers with zero risk of asthma—i.e., those who although smokers will never develop asthma. Smokers with a high pack year history and normal lung function were used as a “low risk” group of smokers, as the Applicants believe it is not possible with current knowledge to identify a lower risk group of smokers. The Applicants believe, without wishing to be bound by any theory, that this approach allows for a more rigorous comparison of low penetrant, high frequency polymorphisms that may confer an increased risk of developing asthma. The Applicants also believe, again without wishing to be bound by any theory, that there may be polymorphisms that confer a degree of protection from asthma which may only be evident if a smoking cohort with normal lung function is utilised as a comparator group. Thus smokers with asthma would be expected to have a lower frequency of these polymorphisms compared to smokers with normal lung function and no diagnosed asthma.

### Methods

### Subject Recruitment

Subjects of European decent who had smoked a minimum of ten pack years and diagnosed with asthma were recruited. Subjects could be of any age and at any stage of treatment after the diagnosis had been confirmed. Subjects were defined as irreversible asthmatic smokers if their FEV1/FVC was <70% and their FEV1% predicted was <70%. One hundred and forty-four subjects were recruited, of these 42% were male, the mean FEV1/FVC (1SD) was 45% (12), mean FEV1 as a percentage of predicted was 41 (15). Mean age, cigarettes per day and pack year history was 63 yrs (9), 23 cigarettes/day (10), and 45 pack years (19), respectively. Mean age of onset of asthma was 35 yrs (21). Ninety European subjects who had smoked a minimum of fifteen pack years and who had been diagnosed with asthma with FEV1% predicted >70% and FEV1/FVC>50% were also studied. This control group was recruited through clubs for the elderly and consisted of 45% male, the mean FEV1/FVC (1SD) was 73% (9), and mean FEV1 as a percentage of predicted was 94% (14). Mean age, cigarettes per day and pack year history was 61 yrs (11), 26 cigarettes/day (15), and 45 pack years (29), respectively. Mean age of onset of asthma was 33 yrs (24). Using a PCR based method (Sandford et al., 1999), all subjects were genotyped for the α1-antitrypsin mutations (S and Z alleles) those with the ZZ allele were excluded. 190 European blood donors (smoking status unknown) were recruited consecutively through local blood donor services. Sixty-three percent were men and their mean age was 50 years. A summary of the subjects is given below in Table 1.

TABLE 1
Summary of characteristics for the Irreversible
Asthma subjects and resistant asthmatic smokers.

| | Irreversible | | | | |
|---|---|---|---|---|---|
| Parameter | asthma | | Resistant smokers | | |
| Median (IQR) | N = 144 | | N = 90 | | Differences |
| % male | 42% | | 45% | | ns |
| Age (yrs) | 63 | (9) | 61 | (11) | ns |
| Age asthma onset (yrs) | 35 | (21) | 33 | (24) | ns |
| Pack years | 45 | (19) | 45 | (29) | ns |
| Cigarettes/day | 23 | (10) | 26 | (15) | ns |
| FEV1 (L) | 1.1 | (0.5) | 2.5 | (0.6) | P < 0.001 |
| FEV1 % predict | 41 | (15) | 94% | (14) | P < 0.001 |
| FEV1/FVC | 45 | (12) | 73 | (9) | P < 0.001 |

Means and standard deviations

This study shows that polymorphisms found in greater frequency in irreversible asthma patients who smoked (i.e., were susceptible) compared to resistant asthmatic smokers (with near normal lung function) may reflect an increased susceptibility to the development of irreversible asthma. Similarly, polymorphisms found in greater frequency in resistant asthmatic smokers compared to irreversible asthmatic smokers may reflect a protective role.

### Polymorphism Genotyping Using the Sequenom Autoflex Mass Spectrometer

Genomic DNA was extracted from whole blood samples (Maniatis, T., Fritsch, E. F. and Sambrook, J., Molecular Cloning Manual. 1989). Purified genomic DNA was aliquoted (10 ng/ul concentration) into 96 well plates and genotyped on a Sequenom™ system (Sequenom™ Autoflex Mass Spectrometer and Samsung 24 pin nanodispenser) using the following sequences, amplification conditions and methods.

The following conditions were used for the PCR multiplex reaction: final concentrations were for 10× Buffer 15 mM MgCl2 1.25×, 25 mM MgCl2 1.625 mM, dNTP mix 25 mM 500 uM, primers 4 uM 100 nM, Tag polymerase (Quiagen hot start) 0.15 U/reaction, Genomic DNA 10 ng/ul. Cycling times were 95° C. for 15 min, (5° C. for 15 s, 56° C. 30 s, 72° C. 30 s for 45 cycles with a prolonged extension time of 3 min to finish). We used shrimp alkaline phosphotase (SAP) treatment (2 ul to 5 ul per PCR reaction) incubated at 35° C. for 30 min and extension reaction (add 2 ul to 7 ul after SAP treatment) with the following volumes per reaction of: water, 0.76 ul; hME 10× termination buffer, 0.2 ul; hME primer (10 uM), 1 ul; MassEXTEND enzyme, 0.04 ul.

TABLE 2
Sequenom conditions for the polymorphisms genotyping −1

| TERM | SNP ID | 2nd-PCRP | 1st-PCRP |
|---|---|---|---|
| iPLEX | GSTP1 Ile105Val | ACGTTGGATGTGGACATGGTGAATGACGGC | ACGTTGGATGTGGTGCAGATGCTCACATAG |
| | | [SEQ.ID.NO. 1] | [SEQ.ID.NO. 2] |
| iPLEX | ICAM1 E469K A/G | ACGTTGGATGACTCACAGAGCACATTCACG | ACGTTGGATGTGTCACTCGAGATCTTGAGG |
| | | [SEQ.ID.NO. 3] | [SEQ.ID.NO. 4] |
| iPLEX | CD14 | ACGTTGGATGAGACACAGAACCCTAGATGC | ACGTTGGATOCAATGAAGGATGTTTCAGGG |
| | | [SEQ.ID.NO. 5] | [SEQ.ID.NO. 6] |
| iPLEX | MEN Try 113 His | ACGTTGGATGTGGAAGAAGCAGGTGGAGAT | ACGTTGGATGCTGGCGTTTTGCAAACATAC |
| | | [SEQ.ID.NO. 7] | [SEQ.ID.NO. 8] |
| iPLEX | NAT2 Arg197Gln | ACGTTGGATGTGGAGACGTCTGCAGGTATG | ACGTTGGATGCCTGCCAAAGAAGAAACACC |
| | | [SEQ.ID.NO. 9] | [SEQ.ID.NO. 10] |
| iPLEX | RANTES −403 A/T | ACGTTGGATGTGAGTCTTCAAAGTTCCTGC | ACGTTGGATGAACATCCTTCCATGGATGAG |
| | | [SEQ.ID.NO. 11] | [SEQ.ID.NO. 12] |
| iPLEX | TNF 489 G/A | ACGTTGGATGACATCTCTTTCTGCATCCCC | ACGTTGGATGGAAAGATGIGCGCTGATAGG |
| | | [SEQ.ID.NO. 13] | [SEQ.ID.NO. 14] |
| iPLEX | ADAM33 + 2151 G/C | ACGTTGGATGAAACCATGAcACCTTCCTGC | ACGTTGGATGAGTCGGTAGCAACACCAGG |
| | | [SEQ.ID.NO. 15] | [SEQ.ID.NO. 16] |

TABLE3
Sequenom conditions for the polymorphisms genotyping -2

| SNP_ID | AMP_LEN | UP_CONF | MP_CONF | Tm(NN) | PcGC | PWARN | UEP_DIR | UEP_MASS |
|---|---|---|---|---|---|---|---|---|
| GSTP1 Ile105Val | 104 | 98.5 | 64.1 | 47.6 | 56.3 | I | F | 4786.1 |
| ICAM1 E469K A/G | 115 | 99.1 | 64.1 | 47.9 | 50 | DI | R | 5105.3 |
| CD14 | 91 | 98.2 | 64.1 | 45.9 | 47.1 | D | F | 5136.4 |
| MEH Try 113 His | 98 | 96 | 64.1 | 49.1 | 47.4 | | F | 5876.8 |
| NAT2 Arg197Gln | 120 | 97 | 64.1 | 46.7 | 26.1 | D | R | 6996.6 |
| RANTES −403 A/T | 89 | 96.7 | 64.1 | 45.1 | 27.3 | | F | 7276.8 |
| TNF 489 G/A | 93 | 99.8 | 76.8 | 49.7 | 56.3 | I | R | 4719.1 |
| ADAM33 +2151 G/C | 110 | 95.6 | 76.8 | 55 | 70.6 | H | F | 5098.3 |

TABLE 4
Sequenom conditions for the polymorphisms genotyping −3

| | | EXT1_{—} | EXT1_{—} | | EXT2_{—} |
|---|---|---|---|---|---|
| SNP_ID | UEP_SEQ | CALL | MASS | EXT1_SEQ | CALL |
| GSTP1 Ile105Val | CCTCCGCTGCAAATAC | A | 5057.3 | CCTCCGCTGCAAATACA | G |
| | [SEQ.ID.NO. 17] | | | [SEQ.ID.NO. 18] | |
| ICAM1 E469K NG | TACATTCACGGTCACCT | G | 5352.5 | tACATTCACGGTCACCTC | A |
| | [SEQ.ID.N0. 19] | | | [SEQ.ID.NO. 20] | |
| CD14 | AATCCTTCCTGTTACGG | C | 5383.5 | AATCCTTCCTGTTACGGC | T |
| | [SEQ.ID.NO. 21] | | | [SEQ.ID.NO. 22] | |
| MEH Try 113 His | GGTGGAGATTCTCAACAGA | C | 6124 | GGTGGAGATTCTCAACAGAC | T |
| | [SEQ.ID.NO. 23] | | | [SEQ.ID.NO. 24] | |
| NAT2 Arg197Gln | TAGACTCAAAATCTTCAATTGTT | G | 7243.8 | TAGACTCAAAATCTTCAATTGTTC | A |
| | [SEQ.ID.NO. 25] | | | [SEQ.ID.NO. 26] | |
| RANTES −403 A/T | caTGCTTATTCATTACAGATCTTA | C | 7523.9 | caTGCTTATTCATTACAGATCTTAC | T |
| | [SEQ.ID.NO. 27] | | | [SEQ.ID.NO. 28] | |
| TNF 489 G/A | TOCCCGTCTTTCTCCA | G | 4966.3 | TCCCCGTCTITCTCCAC | A |
| | [SEQ.ID.NO. 29] | | | [SEQ.ID.NO. 30] | |
| ADAM33 + 2151 G/C | CTGCTGCCTCTGCTCCCAGG | C | 5345.5 | CTGCCTCTGCTCCCAGGC | G |
| | [SEQ.ID.N0. 31] | | | [SEQ.ID.NO. 32] | |

TABLE 5
Sequenom conditions for the polymorphism genotyping −4

| SNP_ID | EXT2_MASS | EXT2_SEQ | |
|---|---|---|---|
| GSTPI Ile105Val | 5073.3 | CCTCCGCTGCAAATACG | [SEQ.ID.NO. 33] |
| ICAM1 E469K a/G | 5432.4 | TACATTCACGGTCACCTT | [SEQ.ID.NO. 34] |
| CD14 | 5463.4 | AATCCTTCCTGTTACGGT | [SEQ.ID.NO. 35] |
| MEN Try 113 His | 6203.9 | GGTGGAGATTCTCAACAGAT | [SEQ.ID.NO. 36] |
| NAT2 Arg197Gln | 7323.7 | TAGACTCAAAATCTTCAATTGTTT | [SEQ.ID.NO. 37] |
| RANTES −403 a/T | 7603.9 | CATGCTTATTGATTACAGATCTTAT | [SEQ.ID.NO. 38] |
| TNF 489 G/A | 5046.2 | TCCCCGTCTTTCTCCAT | [SEQ.ID.NO. 39] |
| ADAM33 +2151 G/C | 5385.5 | CTGCCTCTGCTCCCAGGG | [SEQ.ID.NO. 40] |

### Results

TABLE 6
Glutathione S Transferase P1 Ile 105 Val A/G polymorphism allele
and genotype frequencies in the irreversible (susceptible) asthmatic
patients, resistant asthmatic smokers and controls.

| | Allele* | | Genotype | | |
|---|---|---|---|---|---|
| Frequency | A | G | AA | AG | GG |
| Controls n = 185 (%) | 232 (63%) | 138 (37%) | 70 (38%) | 92 (50%) | 23 (12%) |
| Irreversible asthma n = 142 (%) | 175 (62%) | 109 (38%) | 52 (37%) | 71 (50%) | 19 (13%) |
| Resistant asthma n = 87 (%) | 115 (66%) | 57 (33%) | 39 (44%) | 37 (43%) | 10 (11%) |

*number of chromosomes (2n)
Genotype, AA vs AG/GG for irreversible asthma vs resistant asthmatic smokers, Odds ratio (OR) = 0.70, 95% confidence limits 0.4-1.3, χ² (Yates uncorrected) = 1.70, p = 0.19, AA genotype = protective

TABLE 7
N-Acetyltransferase 2 Arg 197 Gln G/A polymorphism allele
and genotype frequencies in the irreversible (susceptible)
asthmatic patients and resistant asthmatic smokers.

| | Allele* | | Genotype | | |
|---|---|---|---|---|---|
| Frequency | A | G | AA | AG | GG |
| Irreversible asthma n = 116 | 72 (31%) | 160 (69%) | 11 (9%) | 50 (43%) | 55 (47%) |
| Resistant asthma n = 83 (%) | 43 (26%) | 123 (74%) | 2 (2%) | 39 (46%) | 42 (50%) |

*number or chromosomes (2n)
Genotype. AA vs AG/GG for Irreversible asthma vs resistant asthma, Odds ratio (OR) = 4.24, 95% confidence limits = 0.9-29, χ² (Yates uncorrected) = 3.96, p = 0.05, AA = susceptibility

TABLE 8
Tissue Necrosis Factor α +489 G/A polymorphism allele and genotype frequency
in the irreversible (susceptible) asthmatic patients and resistant asthmatic smokers.

| | Allele* | | Genotype | | |
|---|---|---|---|---|---|
| Frequency | A | G | AA | AG | GG |
| Irreversible asthma n = 137 (%) | 18 (7%) | 256 (93%) | 1 (1%) | 16 (12%) | 120 (87%) |
| Resistant asthma n = 83 (%) | 6 (4%) | 360 (96%) | 0 (0%) | 6 (7%) | 77 (93%) |

*number of chromosomes (2n)
Genotype. AA/AG vs GG for Irreversible asthma vs resistant asthma, Odds ratio (OR) = 1.82, 95% confidence limits 0.6-5.4 un, χ² (Yates corrected) = 1.48, p = 0.22, AA/AG = susceptibility (GG = protective)
Allele. A vs G for Irreversible asthma vs resistant, Odds ratio (OR) = 1.88, 95% confidence limits 0.7-5.4, χ² (Yates uncorrected) = 1.75, p = 0.19, A = susceptibility

TABLE 9
CD-14 −159 C/T polymorphism allele and genotype frequency in the irreversible
(susceptible) asthmatic patients and resistant asthmatic smokers.

| | Allele* | | Genotype | | |
|---|---|---|---|---|---|
| Frequency | C | T | CC | CT | TT |
| Irreversible asthma n = 139 (%) | 131 (47%) | 147 (53%) | 30 (22%) | 71 (51%) | 38 (27%) |
| Resistant asthma n = 87 (%) | 92 (53%) | 82 (47%) | 29 (33%) | 34 (39%) | 24 (28%) |

*number of chromosomes (2n)
Genotype. CC vs CT/TT for Irreversible asthma vs resistant asthma, Odds ratio (OR) = 0.55, 95% confidence limits 0.3-1.1, χ² (Yates uncorrected) = 3.83, p = 0.05. CC protective

TABLE 10
ADAM 33 +2151 G/C polymorphism allele and genotype frequency in the irreversible
(susceptible) asthmatic patients and resistant asthmatic smokers.

| | Allele* | | Genotype | | |
|---|---|---|---|---|---|
| Frequency | C | G | CC | CG | GG |
| Irreversible asthma n = 141 (%) | 74 (26%) | 208 (74%) | 9 (6%) | 56 (40%) | 76 (54%) |
| Resistant asthma n = 87 (%) | 55 (32%) | 119 (68%) | 6 (7%) | 43 (49%) | 38 (43%) |

*number of chromosomes (2n)
Genotype. CC/CG vs GG for Irreversible asthma vs resistant asthma, Odds ratio (OR) = 0.66, 95% confidence limits 0.4-1.2, χ² (Yates uncorrected) = 2.25, p = 0.13. CC/CG protective (GG = susceptibility)
Allele. C vs G for Irreversible asthma vs resistant asthma, Odds ratio (OR) = 0.77, 95% confidence limits 0.5-1.2, χ² (Yates uncorrected) = 1.52, p = 0.22, C = protective

TABLE 11
RANTES −403 C/T polymorphism allele and genotype frequency in the irreversible
(susceptible) asthmatic patients and resistant asthmatic smokers.

| | Allele* | | Genotype | | |
|---|---|---|---|---|---|
| Frequency | C | T | CC | CT | TT |
| Irreversible asthma n = 104 (%) | 169 (81%) | 39 (19%) | 66 (63%) | 37 (36%) | 1 (1%) |
| Resistant asthma n = 73 (%) | 119 (82%) | 82 (18%) | 50 (68%) | 19 (26%) | 4 (5%) |

*number of chromosomes (2n)
Genotype. TT vs CT/CC for Irreversible asthma vs resistant asthma, Odds ratio (OR) = 0.17, 95% confidence limits 0.01-1.6, χ² (Yates uncorrected) = 3.19, p = 0.07. TT = protective

TABLE 12
Microsomal hypoxide hydrolase Tyr 113 His T/C (exon3) polymorphism
allele and genotype frequency in the irreversible (susceptible)
asthmatic patients and resistant asthmatic smokers.

| | Allele* | | Genotype | | |
|---|---|---|---|---|---|
| Frequency | C | T | CC | CT | TT |
| Irreversible asthma n = 121 (%) | 80 (33%) | 162 (67%) | 19 (16%) | 42 (35%) | 60 (50%) |
| Resistant asthma n = 82 (%) | 50 (30%) | 114 (70%) | 7 (9%) | 36 (44%) | 39 (47%) |

*number of chromosomes (2n)
Genotype. CC vs CT/TT for Irreversible asthma vs resistant asthma, Odds ratio (OR) = 2.0, 95% confidence limits 0.7-5.5, χ² (Yates uncorrected) = 2.25, p = 0.13. CC = susceptibility

TABLE 13
ICAM-1 E469K polymorphism allele and genotype frequency in the irreversible
(susceptible) asthmatic patients and resistant asthmatic smokers.

| | Allele* | | Genotype | | |
|---|---|---|---|---|---|
| Frequency | A | G | AA | AG | GG |
| Irreversible asthma n = 129 (%) | 170 (66%) | 88 (34%) | 51 (40%) | 68 (53%) | 10 (8%) |
| Resistant asthma n = 78 (%) | 99 (63%) | 57 (37%) | 25 (32%) | 49 (63%) | 4 (5%) |

*number of chromosomes (2n)
Genotype. AA vs AG/GG for Irreversible asthma vs resistant asthma, Odds ratio (OR) = 1.39, 95% confidence limits 0.7-2.6, χ² (Yates uncorrected) = 1.17, p = 0.28. AA = susceptibility

TABLE 14
Summary table of protective and susceptibility
polymorphisms in irreversible asthmatic smokers
relative to resistant asthmatic smokers.

| Gene | Polymorphism | Genotype | Role |
|---|---|---|---|
| Glutathione S | GSTP1 Ile 105 Val A/G | AA | protective |
| Transferase P | | | |
| N-acetyltransferase | NAT2 Arg 197 Gln A/G | AA | susceptibility |
| 2 (NAT2) | | | |
| Tissue Necrosis | TNF α +489 G/A | AA/AG | susceptibility |
| Factor α | | GG | protective |
| CD14 | CD-14 −159 C/T | CC | protective |
| ADAM 33 | ADAM 33 +2151 G/C | CC/CG | protective |
| | | GG | susceptibility |
| RANTES | RANTES −403 C/T | TT | protective |
| Microsomal epoxide | MEH Tyr 113 His T/C | CC | susceptibility |
| hydrolase (MEH) | (Exon3) | | |
| Intra-cellular | ICAM-1 E469K A/G | AA | susceptibility |
| adhesion | | | |
| molecule (ICAM1) | | | |

Table 15 below presents the SNP score for resistant asthmatic smokers and irreversible asthmatics. The SNP score is derived by assigning each of the selected susceptibility SNPs ICAM1 AA, TNFα AA/AG, NAT2 AA, and MEH CC a value (here, +1), and each of the selected protective SNPs GSTP1 AA, RANTES TT, CD 14 CC and ADAM 33 CC/CG a value (here, −1), and combining the scores to give a net score.

TABLE 15
SNP score for resistant asthmatic smokers and irreversible asthmatic smokers.

| | SNP score | | | | | |
|---|---|---|---|---|---|---|
| Cohort | ≦−3 | −2 | −1 | 0 | ≧1 | Total |
| Resistant asthmatic | 7 (8%) | 15 (17%) | 35 (39%) | 28 (31%) | 5 (5%) | 90 (100%) |
| smokers n = 90 | | | | | | |
| Susceptible asthmatic | 2 (1%) | 18 (13%) | 41 (28%) | 56 (39%) | 27 (19%) | 144 (100%) |
| smokers n = 144 | | | | | | |
| % susceptible to | 22% | 54% | 54% | 67% | 84% | 234 |
| irreversible asthma | | | | | | |

χ² = 6.4, P = 0.003.

### Discussion

The above results show that several polymorphisms were associated with either increased or decreased risk of developing asthma. The associations of individual polymorphisms on their own, while of discriminatory value, are unlikely to offer an acceptable prediction of disease. However, in combination these polymorphisms distinguish susceptible subjects from those who are resistant (for example, between the smokers who develop asthma and those with the least risk with comparable smoking exposure). The polymorphisms represent both promoter polymorphisms, thought to modify gene expression and hence protein synthesis, and exonic polymorphisms known to alter amino-acid sequence (and likely expression and/or function) in a number of genes involved in processes known to underlie lung remodelling and asthma. The polymorphisms identified here are found in genes encoding proteins central to these processes which include inflammation, matrix remodelling, oxidant stress, DNA repair, cell replication and apoptosis.

In the comparison of smokers with irreversible asthma and matched resistant asthmatic smokers with near normal lung function, several polymorphisms were identified as being found in significantly greater or lesser frequency than in the comparator groups (sometimes including the blood donor cohort). Due to the small cohort of asthma patients, polymorphisms where there are only trends towards differences (P=0.06−0.28) were included in the analyses.
In the analysis of the Ile 105 Val A/G polymorphism of the Glutathione S Transferase gene, the AA genotype was found to be greater in the smoking resistant cohort compared to the irreversible asthma cohort (OR=0.70, P=0.19) consistent with a protective role (see Table 6).
In the analysis of the Arg 197 Gln G/A polymorphism of the N-Acetyltransferase 2 gene, the AA genotype was found to be significantly greater in the irreversible asthma cohort compared to the smoking resistant cohort (OR=4.24, P=0.05) consistent with a susceptibility role (see Table 7).
In the analysis of the +489 G/A polymorphisms of the Tissue Necrosis Factor α gene, the A allele, and AA and AG genotypes were found to be greater in the irreversible asthma cohort compared to the resistant smoker cohort (OR=1.88, P=0.19 and OR=1.82, P=0.22, respectively), consistent with a susceptibility role. In contrast, the GG genotype was found to be greater in the resistant smoker cohort compared to the irreversible asthma cohort, consistent with a protective role (see Table 8).
In the analysis of the −159 C/T polymorphism of the CD14 gene, the CC genotype was found to be significantly greater in the smoking resistant cohort compared to the irreversible asthma cohort (OR=0.55, P=0.05) consistent with a protective role (Table 9).
In the analysis of the +2151 G/C polymorphism of the ADAM 33 gene, the C allele, and CC and CG genotypes were found to be greater in the resistant smoker cohort compared to the irreversible asthma cohort (OR=0.77, P=0.22 and OR=0.66, P=0.13, respectively), consistent with a protective role. In contrast, the GO genotype was found to be greater in the irreversible asthma cohort compared to the smoking resistant cohort, consistent with a susceptibility role (see Table 10).
In the analysis of the −403 C/T polymorphism of RANTES gene, the TT genotype was found to be greater in the smoking resistant cohort compared to the irreversible asthma cohort (OR=0.17, P=0.07) consistent with a protective role (Table 11).
In the analysis of the Tyr 113 His T/C (exon 3) polymorphism of the Microsomal hypoxide hydrolase gene, the CC genotype was found to be greater in the irreversible asthma cohort compared to the smoking resistant cohort (OR=2.0, P=0.13) consistent with a susceptibility role (see Table 12).
In the analysis of the E469K polymorphism of the ICAM-1 gene, the AA genotype was found to be greater in the irreversible asthma cohort compared to the smoking resistant cohort (OR=1.39, P=0.28) consistent with a susceptibility role (see Table 13).

It is accepted that the disposition to asthma is the result of the combined effects of the individual's genetic makeup and other factors, including their lifetime exposure to various aero-pollutants including tobacco smoke. Similarly it is accepted that asthma encompasses several obstructive lung diseases and characterised by impaired expiratory flow rates (eg FEV1). The data herein suggest that several genes can contribute to the development of asthma. A number of genetic mutations working in combination either promoting or protecting the lungs from damage are likely to be involved in elevated resistance or susceptibility to asthma.

From the analyses of the individual polymorphisms, 5 protective polymorphisms and 5 susceptibility polymorphisms were identified and analysed for their frequencies in the smoker cohort consisting of low risk smokers, i.e., resistant smokers (near normal lung function) and those with irreversible asthma. When the frequencies of resistant smokers and smokers with irreversible asthma were compared according to the presence or absence of protective polymorphisms selected from a subset of four of the protective polymorphisms (GSTP1 AA, RANTES TT, CD 14 CC and ADAM 33 CC/CG), and for the presence or absence of susceptibility polymorphisms selected from a subset of four of the susceptibility polymorphisms (ICAM1 AA, TNFα AA/AG, NAT2 AA, and MEH CC), significant differences were found (overall [symbol] =16.4, P=0.003) (see Table 15). This analysis suggests smokers with 3+ protective polymorphisms had 3 times more likelihood of being resistant, while those with no protective genotypes were twice as likely to have asthma. This analysis also suggests that smokers with 1+ susceptibility polymorphisms were 5 times more likely to have irreversible asthma. Examined another way, the chance of having irreversible asthma diminished from 84% to 67%, to 54%, to 22%, in smokers with 1+ susceptibility polymorphisms, 0, 1 or 2 protective polymorphisms, or 3+ protective polymorphisms, respectively.

These findings indicate that the methods of the present invention may be predictive of asthma in an individual well before symptoms present.

These findings therefore also present opportunities for therapeutic interventions and/or treatment regimens, as discussed herein. Briefly, such interventions or regimens can include the provision to the subject of motivation to implement a lifestyle change, or therapeutic methods directed at normalising aberrant gene expression or gene product function. For example, a first allele may be associated with decreased expression of a gene relative to that observed with the alternative, second allele. Where the first allele is protective with respect to risk of developing asthma, a suitable therapy in subjects known to possess the second allele can be the administration of an agent capable of decreasing expression of the gene. An alternative suitable therapy can be the administration to such a subject of an inhibitor of the activity of the gene-product, and/or additional therapeutic approaches such as gene therapy or RNAi. In another example, a first allele is associated with decreased expression of a gene, and is also associated with susceptibility to asthma. A suitable therapy in, subjects known to possess the first allele can be the administration of an agent capable of increasing expression of the gene. An alternative therapy may be to administer the gene product or a functional analogue thereof to a subject or to otherwise augment the gene product levels in the subject. In another example, a given susceptibility genotype is associated with increased expression of a gene relative to that observed with the protective genotype. A suitable therapy in subjects known to possess the susceptibility genotype is the administration of an agent capable of reducing expression of the gene, for example using antisense or RNAi methods. An alternative suitable therapy can be the administration to such a subject of an inhibitor of the gene product. In still another example, a susceptibility genotype present in the promoter of a gene is associated with increased binding of a repressor protein and decreased transcription of the gene, A suitable therapy is the administration of an agent capable of decreasing the level of repressor and/or preventing binding of the repressor, thereby alleviating its downregulatory effect on transcription. An alternative therapy can include gene therapy, for example the introduction of at least one additional copy of the gene having a reduced affinity for repressor binding (for example, a gene copy having a protective genotype).

Suitable methods and agents for use in such therapy are well known in the art, and are discussed herein.

The identification of both susceptibility and protective polymorphisms as described herein also provides the opportunity to screen candidate compounds to assess their efficacy in methods of prophylactic and/or therapeutic treatment. Such screening methods involve identifying which of a range of candidate compounds have the ability to reverse or counteract a genotypic or phenotypic effect of a susceptibility polymorphism, or the ability to mimic or replicate a genotypic or phenotypic effect of a protective polymorphism.

Still further, methods for assessing the likely responsiveness of a subject to an available prophylactic or therapeutic approach are provided. Such methods have particular application where the available treatment approach involves restoring the physiologically active concentration of a product of an expressed gene from either an excess or deficit to be within a range which is normal for the age and sex of the subject. In such cases, the method comprises the detection of the presence or absence of a susceptibility polymorphism which when present either upregulates or down-regulates expression of the gene such that a state of such excess or deficit is the outcome, with those subjects in which the polymorphism is present being likely responders to treatment.

### EXAMPLE 2

Table 16 below presents representative examples of polymorphisms in linkage disequilibrium with the polymorphisms specified herein. Examples of such polymorphisms can be located using public databases, such as that available at www.hapmap.org. Specified polymorphisms are indicated in parentheses. The rs numbers provided are identifiers unique to each polymorphism.

TABLE 16
Polymorphism reported to be in LD with polymorphisms specified herein.
GSTP1

| | | | | |
|---|---|---|---|---|
| rs656652 | rs6591255 | rs762803 | rs625978 | rs8191430 |
| rs8191449 | rs8591251 | rs6591256 | rs947894 (Ile 105 Val A/G) | rs12278098 |
| rs8191431 | rs612020 | rs8191432 | rs4986948 | rs12284337 |
| rs7109914 | rs675554 | rs12574108 | rs4147580 | rs749174 |
| rs6591252 | rs8191436 | rs8191450 | rs597717 | rs8191437 |
| rs743679 | rs683489 | rs17593068 | rs1799811 | rs597297 |
| rs8191438 | rs11553890 | rs6591253 | rs8191439 | rs4986949 |
| rs6591254 | rs8191440 | rs8191451 | rs7927381 | rs8191441 |
| rs1871042 | rs7940813 | rs1079719 | rs11553892 | rs593055 |
| rs1871041 | rs4891 | rs7927657 | rs4147581 | rs6413486 |
| rs614080 | rs8191444 | rs5031031 | rs7941395 | rs8191445 |
| rs947395 | rs7941648 | rs2370143 | rs7945035 | rs8191446 |
| rs2370141 | rs3891249 | rs2370142 | rs8191447 | rs7949394 |
| rs12796085 | rs7949587 | rs8191448 | | |

NAT2

| | | | | |
|---|---|---|---|---|
| rs11780272 | rs1495744 | rs2101857 | rs7832071 | rs13363820 |
| rs1805158 | rs6984200 | rs1801279 | rs13277605 | rs1041983 |
| rs9987109 | rs1801280 | rs7820330 | rs4986996 | rs7460995 |
| rs12720065 | rs2087852 | rs4986997 | rs2101684 | rs1799929 |
| rs7011792 | rs1799930 (Arg 197 Gln) | rs1390358 | rs923796 | rs1208 |
| rs4546703 | rs1799931 | rs4634684 | rs2552 | rs2410556 |
| rs4646247 | rs11996129 | rs971473 | rs4621844 | rs721398 |
| rs11785247 | rs1115783 | rs1115784 | rs1961456 | rs1112005 |
| rs11782802 | rs973874 | | | |

TNFα

| | | | | |
|---|---|---|---|---|
| rs1799964 | rs1800630 | rs1799724 | rs1800610 (+489 G/A) | rs3093662 |
| rs3093664 | rs1800629 (1) (−308 G/A) | | | |

CD14

| | | | | |
|---|---|---|---|---|
| rs6877461 | rs3822356 | rs6877437 | rs12153256 | rs11554680 |
| rs12109040 | rs12517200 | rs5744430 | rs5744431 | rs100000092 |
| rs5744433 | rs100000093 | rs4912717 | rs100000094 | rs100000095 |
| rs100000096 | rs6864930 | rs100000097 | rs6864583 | rs6864580 |
| rs6889418 | rs6889416 | rs5744440 | rs5744441 | rs5744442 |
| rs3138074 | rs13166911 | rs2563310 | rs2569193 | rs2569192 |
| rs5744446 | rs5744447 | rs5744448 | rs3138076 | rs12519656 |
| rs5744449 | rs2915863 | rs3138078 | rs6875483 | rs2569191 |
| rs5744451 | rs5744452 | rs100000098 | rs17118968 | rs5744455 |
| rs2569190 (−159 C/T) | rs2569189 | rs2563303 | rs3138079 | rs2228049 |
| rs13753 | rs11556179 | rs4914 | | |

ADAM 33

| | | | | |
|---|---|---|---|---|
| rs2787095 | rs3918391 | rs6084434 | rs3918392 | rs511898 |
| rs2485700 | rs2485699 | rs6076536 | rs2271511 | rs730472 |
| rs2271510 | rs7267301 | rs3918402 | rs2280094 | rs2280093 |
| rs3918393 | rs2280092 | rs3918394 | rs11908384 | rs3918395 |
| rs6037648 | rs615436 | rs557954 | rs612709 | rs12481140 |
| rs3918398 | rs528557 (+2151 G/C) | rs2853209 | rs598418 | rs44707 |
| rs597980 | rs3918397 | rs6052011 | rs574174 | rs2280091 |
| rs2280090 | rs2280089 | rs630712 | rs12479696 | rs6115987 |
| rs6115986 | rs678881 | rs628977 | rs628965 | rs543749 |
| rs3918401 | rs3918400 | rs677044 | rs11905233 | rs2787094 |
| rs3746631 | | | | |

RANTES

| | | | | |
|---|---|---|---|---|
| rs2107538 (−403 C/T) | rs1800825 | rs2280788 (−28 C/6) | rs2280789 | rs7220144 |
| rs16963927 | rs16971620 | rs9889874 | rs9912552 | rs4796120 |
| rs8069014 | rs9898100 | rs3817655 | rs9915517 | |

mEH

| | | |
|---|---|---|
| rs 1051740 (Tyr 113 His exon 3 T/C) | rs2234922 (His139Arg) | Region of low LD |

ICAM1

| | | | | |
|---|---|---|---|---|
| rs1799959 | rs5493 | rs5030381 | rs5494 | rs3093033 |
| rs5495 | rs1801714 | rs13306429 | rs2071441 | rs5496 |
| rs5497 | rs13306430 | rs5498 (E469K A/G) | rs5030400 | rs2071440 |
| rs5499 | rs3093032 | rs1057981 | rs5500 | rs5501 |
| rs5030383 | rs281436 | rs823366 | rs281437 | rs3093030 |
| rs5030384 | rs5030385 | re2735442 | rs2569693 | rs281439 |
| rs281440 | rs2569694 | rs11575073 | rs2569695 | rs2075741 |
| rs11575074 | rs2569696 | rs2735439 | rs2569697 | rs2075742 |
| rs2569698 | rs11669397 | rs901886 | rs885742 | rs2569599 |
| rs1056538 | rs11549918 | rs2569700 | rs2228615 | rs2569701 |
| rs2569702 | rs2735440 | rs2569703 | rs10418913 | rs1056536 |
| rs2569704 | rs11673661 | rs2589705 | rs10402760 | rs2569706 |
| rs2569707 | rs2735441 | rs2436545 | rs2436546 | rs2916060 |
| rs2916059 | rs2916058 | rs2569708 | rs12972990 | rs735747 |
| rs885743 | | | | |

### INDUSTRIAL APPLICATION

The present invention is directed to methods for assessing a subject's risk of developing asthma. The methods comprise the analysis of polymorphisms herein shown to be associated with increased or decreased risk of developing asthma, or the analysis of results obtained from such an analysis. The use of polymorphisms herein shown to be associated with increased or decreased risk of developing asthma in the assessment of a subject's risk are also provided, as are nucleotide probes and primers, kits, and microarrays suitable for such assessment. Methods of treating subjects having the polymorphisms herein described are also provided. Methods for screening for compounds able to modulate the expression of genes associated with the polymorphisms herein described are also provided.

### PUBLICATIONS

Sears M R, Greene J M, Willan A R, Wiecek E M, Taylor D R, Flannery E M, Cowan J O, Herbison G P, Silva P A, Poulton R. A longitudinal, population-based, cohort study of childhood asthma followed to adulthood. N Engl J Med 2003; 349:1414-1422,
2. Ulrik C S, Lange P. Decline of lung function in adults with bronchial asthma. Am J Respir Crit Care Med 1994; 150:629-634.
3. Lange P, Parner J, Vestbo J, Schnohr P, Jensen G. A 15-year follow-up study of ventilatory function in adults with asthma. N Engl J Med 1998; 339:1194-1200.
4. Holgate S T. The epidemic of asthma and allergy. J R Soc Med 2004; 97:103-110.
5. Wang M L, Petsonk E L, Beeckman L A, Wagner G R, Clinically important FEV₁ declines among coal miners; an exploration of previously unrecognised determinants. Occup Environ Med 1999; 56:837-844.
6. Sparrow D, Glynn R J, Cohen M, Weiss S T. The relationship of the peripheral leukocyte count and cigarette smoking to pulmonary function among adult men. Chest 1984; 86:383-386.
7. Sherrill D, Guerra S, Bobadilla A, Barbee R. The role of concomitant respiratory diseases on the rate of decline in FEV₁ among adult asthmatics. Eur Respir J 2003; 21:95-100.
8. Laitinen L A, Laitinen A, Haahtela T. A comparative study of the effects of an inhaled corticosteroid, budesonide, and a β₂-agonist, terbutaline, on airway inflammation in newly diagnosed asthma: a radomized double-blind, parallel-group controlled trial. J Allergy Clin Immunol 1992; 90:32-42.
9. Sont J K., Willems L N, Bel E H, van Krieken J H, Vandenbroucke J P, Sterk P J. Clinical control and histopathologic outcome of asthma when using airway hyperresponsiveness as an additional guide to long-term treatment: the AMPUL Study Group. Am J Respir Crit Care Med 1999; 159:1043-1051.
10. Dompeling E, van Schayck C P, van Grunsven P M, van Herwaarden C L, Akkermans R, Molema I, Folgering H, van Weel C. Slowing the deterioration of asthma and chronic obstructive pulmonary disease observed during bronchodilator therapy by adding inhaled corticosteroids: a 4-year prospective study. Ann Intern Med 1993; 118:770-778.
11, Gergen P J, Weiss K B. The increasing problem of asthma in the United States. Am Rev Respir Dis 1992; 144: 823-824,
12. Duffy D L, Mitchell C A, Martin N G. Genetic and envioronmental risk factors for asthma—a Cotwin-control study. Am J Respir Cult Care Med 1998; 157: 840-845.
13. Sherrill D L, Stein R, Kurzius-Spencer M, Martinez F. On the early sensitization to allergens and development of respiratory symptoms. Clin Exp Allergy 1999; 29: 905-911.

All patents, publications, scientific articles, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents.

The specific methods and compositions described herein are representative of various embodiments or preferred embodiments and are exemplary only and not intended as limitations on the scope of the invention. Other objects, aspects, examples and embodiments will occur to those skilled in the art upon consideration of this specification, and are encompassed within the spirit of the invention as defined by the scope of the claims, It will be readily apparent to one skilled in the art that varying substitutions and modifications can be made to the invention disclosed herein without departing from the scope and spirit of the invention. The invention illustratively described herein suitably can be practiced in the absence of any element or elements, or limitation or limitations, which is not specifically disclosed, herein as essential. Thus, for example, in each instance herein, in embodiments or examples of the present invention, any of the terms “comprising”, “consisting essentially of”, and “consisting of” may be replaced with either of the other two terms in the specification, thus indicating additional examples, having different scope, of various alternative embodiments of the invention. Also, the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also that as used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional, features, modification and variation of the concepts herein disclosed may be resorted to by those skilled in the art, and that such modifications and variations are considered to be within the scope of this invention as defined by the appended claims.

1. A method of determining a subject's risk of developing asthma comprising analysing a sample from said subject for the presence or absence of at least one polymorphism selected from the group consisting of:
+489 G/A in the gene encoding Tissue Necrosis Factor α (TNF α);
Tyr 113 His T/C (Exon3) in the gene encoding Microsomal epoxide hydrolase (MEH); and
one or more polymorphisms which are in linkage disequilibrium with +489 G/A in the gene encoding TNF α or Tyr 113 His T/C (Exon3) in the gene encoding MEH;
wherein the presence or absence of said at least one polymorphism is indicative of the subject's risk of developing asthma.

2. The method according to claim 1, wherein the method comprises analysing said sample for the presence or absence of one or more further polymorphisms selected from the group consisting of:
Ile 105 Val A/G in the gene encoding Glutathione S Transferase P (GSTP1);
Arg 197 Gln A/G in the gene encoding N-acetyltransferase 2 (NAT2);
−159 C/T in the gene encoding CD14;
+2151 G/C in the gene encoding ADAM 33;
−403 C/T in the gene encoding RANTES;
E469K A/G in the gene encoding Intra-cellular adhesion molecule (ICAM1); and
one or more polymorphisms which are in linkage disequilibrium with Ile 105 Val A/G in the gene encoding GSTP1, Arg 197 Gln A/G in the gene encoding NAT2, −159 C/T in the gene encoding CD14, +2151 G/C in the gene encoding ADAM 33, −403 C/T in the gene encoding RANTES, or E469K A/G in the gene encoding ICAM1.

3. The method according to claim 2, wherein the presence of one or more of polymorphisms selected from the group consisting of:
the Ile 105 Val A/G AA genotype in the gene encoding GSTP1;
the +489 G/A GG genotype in the gene encoding TNF α;
the −159 C/T CC genotype in the gene encoding CD14;
the +2151 G/C CC or CG genotype in the gene encoding ADAM 33; and
the −403 C/T TT genotype in the gene encoding RANTES;
is indicative of a reduced risk of developing asthma.

4. The method according to claim 2, wherein the presence of one or more of polymorphisms selected from the group consisting of:
the Arg 197 Gln A/G AA genotype in the gene encoding NAT2;
the +489 G/A AA or AG genotype in the gene encoding TNF α;
the +2151 G/C GG genotype in the gene encoding ADAM 33;
the Tyr 113 His T/C (Exon3) CC genotype in the gene encoding MEH; and
the E469K A/G AA genotype in the gene encoding ICAM1;
is indicative of an increased risk of developing asthma.

5. A method of assessing a subject's risk of developing asthma said method comprising the steps:
(i) determining the presence or absence of at least one protective polymorphism associated with a reduced risk of developing asthma; and
(ii) in the absence of at least one protective polymorphism, determining the presence or absence of at least one susceptibility polymorphism associated with an increased risk of developing asthma;
wherein the presence of at least one protective polymorphism is indicative of a reduced risk of developing asthma, and wherein the absence of at least one protective polymorphism in combination with the presence of at least one susceptibility polymorphism is indicative of an increased risk of developing asthma.

6. The method according to claim 5, wherein said at least one protective polymorphism is the +489 G/A GG genotype in the gene encoding TNF α.

7. The method according to claim 5, wherein said at least one protective polymorphism is selected from the group consisting of:
the Ile 105 Val A/G AA genotype in the gene encoding GSTP1;
the −159 C/T CC genotype in the gene encoding CD14;
the +2151 G/C CC or CG genotype in the gene encoding ADAM 33; and
the −403 C/T TT genotype in the gene encoding RANTES.

8. The method according to claim 5, wherein said at least one susceptibility polymorphism is a genotype selected from the group consisting of:
the +489 G/A AA or AG genotype in the gene encoding TNF α; and
the Tyr 113 His T/C (Exon3) CC genotype in the gene encoding MEH.

9. The method according to claim 5, wherein said at least one susceptibility polymorphism is a genotype selected from the group consisting of:
the Arg 197 Gln A/G AA genotype in the gene encoding NAT2;
the +2151 G/C GG genotype in the gene encoding ADAM 33; and
the E469K A/G AA genotype in the gene encoding ICAM1.

10. The method according to claim 5, wherein the presence of two or more protective polymorphisms irrespective of the presence of one or more susceptibility polymorphisms is indicative of reduced risk of developing asthma.

11. The method according to claim 5, wherein the presence of two or more susceptibility polymorphisms is indicative of an increased risk of developing asthma.

12. A method of determining a subject's risk of developing asthma, comprising analysing a sample from said subject for the presence of two or more polymorphisms selected from the group consisting of:
+489 G/A in the gene encoding Tissue Necrosis Factor α (TNF α);
Tyr 113 His T/C (Exon3) in the gene encoding Microsomal epoxide hydrolase (MEH);
Ile 105 Val A/G in the gene encoding Glutathione S Transferase P (GSTP1);
Arg 197 Gln A/G in the gene encoding N-acetyltransferase 2 (NAT2);
−159 C/T in the gene encoding CD14;
+2151 G/C in the gene encoding ADAM 33;
−403 C/T in the gene encoding RANTES;
E469K A/G in the gene encoding Intra-cellular adhesion molecule (ICAM1); and
one or more polymorphisms which are in linkage disequilibrium with +489 G/A in the gene encoding TNF α, Tyr 113 His T/C (Exon3) in the gene encoding MEH, Ile 105 Val A/G in the gene encoding GSTP1, Arg 197 Gln A/G in the gene encoding NAT2, −159 C/T in the gene encoding CD14, +2151 G/C in the gene encoding ADAM 33, −403 C/T in the gene encoding RANTES, or E469K A/G in the gene encoding ICAM1.

13. The method according to claim 1, wherein said method comprises further analyzing one or more epidemiological risk factors.

14. A method of determining a subject's risk of developing asthma, said method comprising the steps:
(i) providing the result of one or more genetic tests of a sample from said subject; and
(ii) analysing the result for the presence or absence of one or more polymorphisms selected from the group consisting of:
+489 G/A in the gene encoding Tissue Necrosis Factor α (TNF α);
Tyr 113 His T/C (Exon3) in the gene encoding Microsomal epoxide hydrolase (MEH); and
one or more polymorphisms which are in linkage disequilibrium with +489 G/A in the gene encoding TNF α or Tyr 113 His T/C (Exon3) in the gene encoding MEH;
wherein a result indicating the presence or absence of one or more of said polymorphisms is indicative of the subject's risk of developing asthma.

15. The method according to claim 14, wherein a result indicating the presence of the +489 G/A GG genotype in the gene encoding TNF α is indicative of a reduced risk of developing asthma.

16. The method according to claim 14, wherein a result indicating the presence of one or more of the polymorphisms selected from the group consisting of:
the +489 G/A AA or AG genotype in the gene encoding TNF α; and
the Tyr 113 His T/C (Exon3) CC genotype in the gene encoding MEH; is indicative of an increased risk of developing asthma.

17-41. (canceled)
